(19) United States
(12) Patent Application Publication
(10) Pub. No.: US 2007/0231576 A1
(43) Pub. Date: Oct. 4, 2007

(54) Multilayer films comprising tie layer compositions, articles prepared therefrom, and method of making

(76) Inventors: M. Shoen Davis, Mt. Vernon, IN (US); Georgios S. Zafiris, Evansville, IN (US)

Correspondence Address: CANTOR COLBURN, LLP, 55 GRIFFIN ROAD SOUTH, BLOOMFIELD, CT, 06002, US

(21) Appl. No.: 11/239,820

(22) Filed: Sep. 30, 2005

(51) Int. Cl. B32B 27/36

(52) U.S. Cl. 428/412

(57) ABSTRACT

A multilayer film comprising a superstrate, and a tie layer comprising a tie layer composition comprising a polycarbonate and a poly(alkylene ester) is disclosed, wherein a substrate contacted to the tie layer opposite the superstrate has initiation peel strength between the tie layer and the substrate of about 20 to about 60 pounds per linear inch (about 3,500 to about 10,500 Newtons per meter), measured at a 90° peel angle and a peel rate of 12.7 cm/min. An article comprising the multilayer film is disclosed. Methods of forming the multilayer film and the article are also disclosed.

### BACKGROUND

This disclosure relates to multilayer films comprising tie layer compositions, articles prepared therefrom, methods of manufacture, and uses thereof.

Multilayer films prepared from polycarbonate have useful properties such as weatherability, scratch resistance, and high gloss, and can be used as surface finish layers for molded articles. Further, where one or more layers of these multilayer films are used to carry a colorant and/or other additives for obtaining visual effects for the article, the multilayer films are useful as paint-replacement layers for molded articles. Articles for which such multilayer films are useful include automotive applications, specifically horizontal applications such as rooftops, deck lids, exterior panels, and the like.

A multilayer film can be back molded to the substrate material, which provides mechanical support for the multilayer film. To provide adhesion between the multilayer film and substrate, the multilayer film can be constructed with one or more intermediate layers, referred to as “tie layers”, that are useful for providing adhesion between the superstrates having the surface finish properties, and the substrate.

Tie layers currently adequate for applications such as those described above, may nevertheless not be suitable for newer applications with different geometries, and/or for different substrate materials. Newer applications for which tie layers with different interfacial properties are desirable include, for example, those requiring deeper thermoforming draw ratios, i.e. combinations of multilayer films and substrates having thicker layers and/or narrower widths, with smaller interfacial areas between the tie layer and the substrate. In addition, adhesion of present tie layers to low surface energy substrates such as polyolefins may prove unsuitable.

There accordingly remains a need in the art for a tie layer composition suitable for preparing a tie layer having improved adhesion to other layers in the multilayer film and/or improved substrate adhesion.

A tie layer prepared using the tie layer composition also desirably provides a lower defect rate than that obtained with current tie layer compositions.

### SUMMARY OF THE INVENTION

The above-described and other deficiencies of the art are met by an article comprising a polymer substrate and a multilayer film, which comprises: a superstrate comprising a polycarbonate; and a tie layer comprising a tie layer composition comprising a polycarbonate and a poly(alkylene ester). The tie layer is disposed between the substrate and the superstrate, and the article has an initiation peel strength between the tie layer and the substrate of about 20 to about 60 pounds per linear inch (about 3,500 to about 10,500 Newtons per meter), measured at a 90° peel angle and a peel rate of 12.7 cm/min.

In another embodiment, a method of forming a multilayer film comprises coextruding: a superstrate with a first tie layer comprising: a tie layer composition comprising a polycarbonate and a poly(alkylene ester), wherein the superstrate is contacted to the first tie layer, and wherein the initiation peel strength between the tie layer of the multilayer film and a substrate contacted thereto is greater than about 10 pounds per linear inch (1,750 Newtons per meter), measured at a 90° peel angle and a peel rate of 12.7 cm/min.

In another embodiment, a multilayer film comprises a superstrate, wherein the superstrate comprises a polycarbonate, and a tie layer comprising a combination of a polycarbonate, and a poly(alkylene ester), wherein the poly(alkylene ester) comprises poly(1,4-cyclohexanedimethylene-1,4-cyclohexanedicarboxylate), poly((1,4-cyclohexanedimethylene terephthalate)-co-(1,2-ethylene terephthalate)) having less than or equal to 50 wt % of 1,4-cyclohexanedimethylene terephthalate ester units; poly((1,4-cyclohexanedimethylene terephthalate)-co-(1,2-ethylene terephthalate)) having greater than 50 wt % of 1,4-cyclohexanedimethylene terephthalate ester units; or a combination comprising one or more of the foregoing poly(alkylene esters), wherein the polycarbonate and poly(alkylene ester) are present in the tie layer composition in a weight ratio of about 85:15 to about 30:70, and wherein the adhesion between the tie layer and the superstrate, as measured by peel pull strength, is greater than about 10 pounds per linear inch (1,750 Newtons per meter), measured at a 90° peel angle and a peel rate of 12.7 cm/min.

The invention is further described by the following figures.

### BRIEF DESCRIPTION OF THE DRAWINGS

FIG. 1 shows an embodiment of an article comprising a multilayer film and substrate.

FIG. 2 shows another embodiment of an article comprising a multilayer film and substrate.

FIG. 3 shows another embodiment of an article comprising a multilayer film and substrate.

### DETAILED DESCRIPTION

Surprisingly, it has been found that a tie layer prepared from a composition comprising a combination of a polycarbonate and a poly(alkylene ester). has excellent adhesion to both a polycarbonate superstrate and certain polymer substrates. Further, improved adhesion between the superstrate and the substrate is attained, where the initiation adhesion (i.e., the measured adhesion during initiating peeling) is about 20 to about 60 pounds per linear inch (pli) (about 3,500 to about 10,500 Newtons per meter, N/m).

As used herein, a “multilayer film” refers to a films having at least one layer (a “superstrate”) in addition to the tie layer. The superstrate itself may have a single layer or multiple layers.

Both the superstrate and the tile layer comprise a polycarbonate. As used herein, the term “polycarbonate” and “polycarbonate resin” means compositions having repeating structural carbonate units of the formula (1): 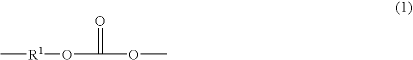
in which greater than about 60 percent of the total number of R¹ groups are aromatic organic radicals and the balance thereof are aliphatic, alicyclic, or aromatic radicals. In one embodiment, each R¹ is an aromatic organic radical, for example a radical of the formula (2):
-A¹-Y¹-A²- (2)
wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, which includes dihydroxy compounds of formula (3):
HO-A¹-Y¹-A²-OH (3)
wherein Y¹, A¹ and A² are as described above. Also included are bisphenol compounds of general formula (4): 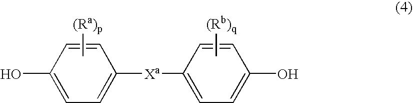
wherein R^{a} and R^{b} each represent a halogen atom or a monovalent hydrocarbon group and may be the same or different; p and q are each independently integers of 0 to 4; and X^{a} represents one of the groups of formula (5): 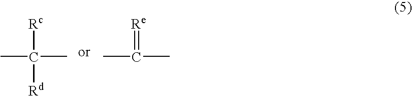
wherein R^{c} and R^{d} each independently represent a hydrogen atom or a monovalent linear or cyclic hydrocarbon group and R^{e} is a divalent hydrocarbon group.

Some illustrative, non-limiting examples of suitable dihydroxy compounds include the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane(“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as combinations comprising at least one of the foregoing dihydroxy compounds.

Specific examples of the types of bisphenol compounds that may be represented by formula (3) include 1,1-bis(4-hydroxyphenyl) methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (PPPBP), and 1,1-bis(4-hydroxy-3-methylphenyl)cyclohexane (DMBPC). Combinations comprising at least one of the foregoing dihydroxy compounds may also be used.

Branched polycarbonates are also useful, as well as blends of a linear polycarbonate and a branched polycarbonate. The branched polycarbonates may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid, and benzophenone tetracarboxylic acid. The branching agents may be added at a level of about 0.05 to about 2.0 wt. %. All types of polycarbonate end groups are contemplated as being useful in the tie layer composition, provided that such end groups do not significantly affect desired properties of the tie layer compositions.

Weight averaged molecular weight (Mw) is a useful measure of the molecular weight of the polycarbonate, wherein Mw is determined by the method of gel permeation chromatography (GPC) using a crosslinked styrene-divinyl benzene GPC column, with a sample concentration of about 1 mg/ml, and as calibrated using polycarbonate standards. Suitable polycarbonates can have an Mw of about 2,000 to about 100,000, specifically about 5,000 to about 75,000, more specifically about 10,000 to about 50,000, and still more specifically about 15,000 to about 40,000.

In a specific embodiment, a polycarbonate is a linear homopolymer derived from bisphenol A, in which each of A¹ and A² is p-phenylene and Y¹ is isopropylidene. The polycarbonates may have an intrinsic viscosity, as determined in chloroform at 25° C., of about 0.3 to about 1.5 deciliters per gram (dl/g), specifically about 0.45 to about 1.0 dl/g. The polycarbonates may have a weight average molecular weight of about 10,000 to about 200,000, specifically about 15,000 to about 100,000, more specifically about 17,000 to about 50,000, as measured by gel permeation chromatography (GPC), using a crosslinked styrene-divinylbenzene column and calibrated to polycarbonate references. GPC samples are prepared at a concentration of about 1 mg/ml, and are eluted at a flow rate of about 1.5 ml/min.

In one embodiment, the polycarbonate has flow properties suitable for the manufacture of thin articles. Melt volume flow rate (often abbreviated MVR) measures the rate of extrusion of a thermoplastics through an orifice at a prescribed temperature and load. Polycarbonates suitable for the formation of thin articles may have an MVR, measured at 300° C./1.2 kg, of 1 to 70 cubic centimeters per 10 minutes (cc/10 min) specifically 2 to 30 cc/10 min. Mixtures of polycarbonates of different flow properties may be used to achieve the overall desired flow property. The polycarbonate has a haze less than 10%, specifically less than or equal to 5%, and more specifically less than or equal to 2%, as measured at a thickness of 3.2 mm according to ASTM D1003-00. The polycarbonate may further have a light transmission greater than or equal to 70%, specifically greater than or equal to 80% and more specifically greater than or equal to 85%, as measured at a thickness of 3.2 mm according to ASTM D1003-00.

In one embodiment, the polycarbonate has flow properties suitable for the manufacture of thin articles. Melt volume flow rate (often abbreviated MVR) measures the rate of extrusion of a thermoplastics through an orifice at a prescribed temperature and load. Polycarbonates suitable for the formation of thin articles can have an MVR, measured at 300° C./1.2 kg, of about 0.4 to about 25 cubic centimeters per 10 minutes (cc/10 min), specifically about 1 to about 15 cc/10 min. Mixtures of polycarbonates of different flow properties can be used to achieve the overall desired flow property.

“Polycarbonates” and “polycarbonate resins” as used herein include the polycarbonates described above, copolymers comprising carbonate units with other polymer units, and combinations of the foregoing other thermoplastic polymers, for example combinations of polycarbonate homopolymers and/or copolymers with polyesters. As used herein, a “combination” is inclusive of all mixtures, blends, alloys, reaction products, and the like.

A specific suitable copolymer is a polyester carbonate, also known as a polyester-polycarbonate. Such copolymers further contain, in addition to recurring carbonate units of the formula (1), repeating ester units of formula (6) 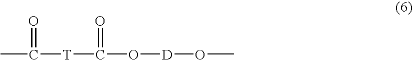
wherein D is a divalent radical derived from a dihydroxy compound, and may be, for example, a C₂₋₁₀ alkylene radical, a C₆₋₂₀ alicyclic radical, a C₆₋₂₀ aromatic radical or a polyoxyalkylene radical in which the alkylene groups contain 2 to about 6 carbon atoms, specifically 2, 3, or 4 carbon atoms; and T divalent radical derived from a dicarboxylic acid, and may be, for example, a C₂₋₁₀ alkylene radical, a C₆₋₂₀ alicyclic radical, a C₆₋₂₀ alkyl aromatic radical, or a C₆₋₂₀ aromatic radical.

In one embodiment, D is a C₂₋₆ alkylene radical. In another embodiment, D is derived from an aromatic dihydroxy compound of formula (7): 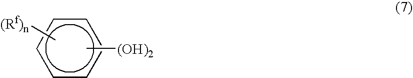
wherein each R^{f} is independently a halogen atom, a C₁₋₁₀ hydrocarbon group, or a C₁₋₁₀ halogen substituted hydrocarbon group, and n is 0 to 4. The halogen is usually bromine. Examples of compounds that may be represented by the formula (7) include resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like; or combinations comprising at least one of the foregoing compounds.

Examples of aromatic dicarboxylic acids that may be used to prepare the polyesters include isophthalic or terephthalic acid, 1,2-di(p-carboxyphenyl)ethane, 4,4′-dicarboxydiphenyl ether, 4,4′-bisbenzoic acid, and mixtures comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or mixtures thereof. A specific dicarboxylic acid comprises a mixture of isophthalic acid and terephthalic acid wherein the weight ratio of terephthalic acid to isophthalic acid is about 91:9 to about 2:98. In another specific embodiment, D is a C₂₋₆ alkylene radical and T is p-phenylene, m-phenylene, naphthalene, a divalent cycloaliphatic radical, or a mixture thereof. This class of polyester includes the poly(alkylene terephthalates).

In an embodiment, the polyester unit of a polyester-polycarbonate is derived from the reaction of a combination of isophthalic and terephthalic diacids (or derivatives thereof) with a dihydroxy compound, wherein the molar ratio of isophthalate units to terephthalate units is 91:9 to 1:98, specifically 85:15 to 3:97, more specifically 80:20 to 5:95, and still more specifically 70:30 to 10:90. In on embodiment, the dihydroxy compound comprises bisphenol A. In another embodiment, the dihydroxy compound comprises resorcinol.

The polycarbonate units are derived from the reaction of a carbonyl source and dihydroxy compounds. In one embodiment, the dihydroxy compounds comprise a mixture of resorcinol and bisphenol A, to provide a polycarbonate having in a molar ratio of resorcinol carbonate units to bisphenol A carbonate units of 0:100 to 99:1. In another embodiment, the dihydroxy compound is bisphenol A.

The molar ratio of ester units to carbonate units in the polyester-polycarbonates may vary broadly, for example 1:99 to 99:1, depending on the desired properties of the final composition. The polyester-polycarbonates have, in one embodiment, a molar ratio of ester units to carbonate units of 1:99 to 25:75, specifically 5:95 to 20:80. In another embodiment, the polyester-polycarbonates have a molar ratio of ester units to carbonate units of 25:75 to 99:1, and more specifically 30:70 to 90:10.

In one embodiment, the polyester-polycarbonate has flow properties suitable for the manufacture of thin articles. Melt volume flow rate (often abbreviated MVR) measures the rate of extrusion of a thermoplastics through an orifice at a prescribed temperature and load. Polycarbonates suitable for the formation of thin articles may have an MVR, measured at 300° C./1.2 kg, of about 0.4 to about 25 cc/10 min., specifically about 5 to about 9 cc/10 min. Mixtures of polycarbonates of different flow properties may be used to achieve the overall desired flow property.

Suitable polycarbonates can be manufactured by processes such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like. Suitable carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors may also be used.

Among the phase transfer catalysts that may be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈₈ aryloxy group. Suitable phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst may be about 0.1 to about 10 wt. % based on the weight of bisphenol in the phosgenation mixture. In another embodiment an effective amount of phase transfer catalyst may be about 0.5 to about 2 wt. % based on the weight of bisphenol in the phosgenation mixture.

Alternatively, melt processes may be used to make the polycarbonates. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue. Suitable polycarbonates can be manufactured by processes such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., 8 to 10. The most commonly used water immiscible solvents include methylene chloride, 1,2-dichloroethane, chlorobenzene, toluene, and the like. Suitable carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors may also be used.

A chain stopper (also referred to as a capping agent) may be included during polymerization. The chain-stopper limits molecular weight growth rate, and so controls molecular weight in the polycarbonate. A chain-stopper may be at least one of mono-phenolic compounds, mono-carboxylic acid chlorides, and/or mono-chloroformates.

For example, mono-phenolic compounds suitable as chain stoppers include monocyclic phenols, such as phenol, C₁₋₂₂ alkyl-substituted phenols, p-cumyl-phenol, p-tertiary-butyl phenol, hydroxy diphenyl; monoethers of diphenols, such as p-methoxyphenol. Alkyl-substituted phenols include those with branched chain alkyl substituents having 8 to 9 carbon atoms. A mono-phenolic UV absorber may be used as capping agent. Such compounds include 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like. Specifically, mono-phenolic chain-stoppers include phenol, p-cumylphenol, and/or resorcinol monobenzoate.

Mono-carboxylic acid chlorides may also be suitable as chain stoppers. These include monocyclic, mono-carboxylic acid chlorides such as benzoyl chloride, C₁₋₂₂ alkyl-substituted benzoyl chloride, toluoyl chloride, halogen-substituted benzoyl chloride, bromobenzoyl chloride, cinnamoyl chloride, 4-nadimidobenzoyl chloride, and mixtures thereof; polycyclic, mono-carboxylic acid chlorides such as trimellitic anhydride chloride, and naphthoyl chloride; and mixtures of monocyclic and polycyclic mono-carboxylic acid chlorides. Chlorides of aliphatic monocarboxylic acids with up to 22 carbon atoms are suitable. Functionalized chlorides of aliphatic monocarboxylic acids, such as acryloyl chloride and methacryoyl chloride, are also suitable. Also suitable are mono-chloroformates including monocyclic, mono-chloroformates, such as phenyl chloroformate, alkyl-substituted phenyl chloroformate, p-cumyl phenyl chloroformate, toluene chloroformate, and mixtures thereof.

The polycarbonates may also be prepared by interfacial polymerization. Rather than utilizing the dicarboxylic acid per se, it is desirable to use the reactive derivatives of the acid, such as the corresponding acid halides, specifically the acid dichlorides and the acid dibromides. Thus, for example instead of using isophthalic acid, terephthalic acid, or mixtures thereof, it is possible to employ isophthaloyl dichloride, terephthaloyl dichloride, and mixtures thereof.

The composition may further comprise a polysiloxane-polycarbonate. The polysiloxane (also referred to herein as polydiorganosiloxane) blocks of the polysiloxane-polycarbonate comprise repeating polydiorganosiloxane units of formula (8): 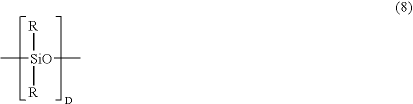
wherein each occurrence of R is same or different, and is a C₁₋₁₃ monovalent organic radical. For example, R may be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ aralkyl group, C₇-C₁₃ aralkoxy group, C₇-C₁₃ alkaryl group, or C₇-C₁₃ alkaryloxy group. The foregoing groups may be fully or partially halogenated with fluorine, chlorine, bromine, or iodine, or a combination thereof. Combinations of the foregoing R groups may be used in the same copolymer.

The value of D in formula (8) may vary widely depending on the type and relative amount of each component in the tie layer composition, the desired properties of the composition, and like considerations. Generally, D may have an average value of 2 to about 1,000, specifically about 2 to about 500, more specifically about 5 to about 100. In one embodiment, D has an average value of about 10 to about 75, and in still another embodiment, D has an average value of about 40 to about 60. Where D is of a lower value, e.g., less than about 40, it may be desirable to use a relatively larger amount of the polycarbonate-polysiloxane copolymer. Conversely, where D is of a higher value, e.g., greater than about 40, it may be necessary to use a relatively lower amount of the polycarbonate-polysiloxane copolymer.

A combination of a first and a second (or more) polysiloxane-polycarbonate may be used, wherein the average value of D of the first polysiloxane-polycarbonate is less than the average value of D of the second polysiloxane-polycarbonate.

In one embodiment, the polydiorganosiloxane blocks are provided by repeating structural units of formula (9): 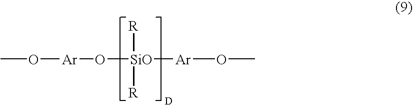
wherein D is as defined above; each R may be the same or different, and is as defined above; and Ar may be the same or different, and is a substituted or unsubstituted C₆-C₃₀ arylene radical, wherein the bonds are directly connected to an aromatic moiety. Suitable Ar groups in formula (9) may be derived from a C₆-C₃₀ dihydroxyarylene compound, for example a dihydroxyarylene compound of formula (3), (4), or (7) above. Combinations comprising at least one of the foregoing dihydroxyarylene compounds may also be used. Specific examples of suitable dihydroxyarlyene compounds are 1,1-bis(4-hydroxyphenyl)methane, 1,1-bis(4-hydroxyphenyl)ethane, 2,2-bis(4-hydroxyphenyl)propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxyphenyl)cyclohexane, bis(4-hydroxyphenyl sulphide), and 1,1-bis(4-hydroxy-t-butylphenyl)propane. Combinations comprising at least one of the foregoing dihydroxy compounds may also be used.

Such units may be derived from the corresponding dihydroxy compound of formula (10): 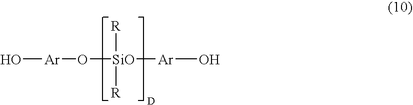
wherein Ar and D are as described above. Compounds of formula (10) may be obtained by the reaction of a dihydroxyarylene compound with, for example, an alpha, omega-bisacetoxypolydiorangonosiloxane under phase transfer conditions.

In another embodiment, polydiorganosiloxane blocks comprises units of formula (11): 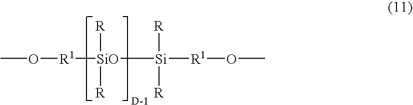
wherein R is as described above, D is 1 to 1000, each occurrence of R¹ is independently a divalent C₁-C₃₀ organic radical, and wherein the polymerized polysiloxane unit is the reaction residue of its corresponding dihydroxy compound. In a specific embodiment, the polydiorganosiloxane blocks are provided by repeating structural units of formula (12) 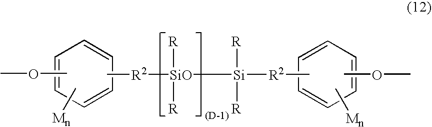
wherein R and D are as defined above. R² in formula (12) is a divalent C₂-C₈ aliphatic group. Each M in formula (12) may be the same or different, and may be a halogen, cyano, nitro, C₁-C₈ alkylthio, C₁-C₈ alkyl, C₁-C₈ alkoxy, C₂-C8 alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkaryl, or C₇-C₁₂ alkaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R² is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a mixture of methyl and trifluoropropyl, or a mixture of methyl and phenyl. In still another embodiment, M is methoxy, n is one, R² is a divalent C₁-C₃ aliphatic group, and R is methyl.

Units of formula (12) may be derived from the corresponding dihydroxy polydiorganosiloxane (13): 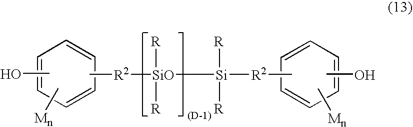
wherein R, D, M, R², and n are as described above. Such dihydroxy polysiloxanes can be made by effecting a platinum catalyzed addition between a siloxane hydride of formula (14): 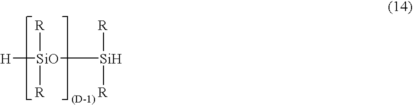
wherein R and D are as previously defined, and an aliphatically unsaturated monohydric phenol. Suitable aliphatically unsaturated monohydric phenols included, for example, eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing may also be used.

The weight ratio of polysiloxane units to carbonate units in the polysiloxane-polycarbonates may vary. For example, the polysiloxane-polycarbonates can have, in one embodiment, a weight ratio of siloxane units to carbonate units of 1:99 to 50:50, specifically 2:98 to 30:70, and more specifically 3:97 to 25:75.

In a specific embodiment, the polysiloxane-polycarbonate can comprise polysiloxane units, and carbonate units derived from bisphenol A in which each of A¹ and A² is p-phenylene and Y¹ is isopropylidene. Polysiloxane-polycarbonates may have a weight average molecular weight of 2,000 to 100,000, specifically 5,000 to 50,000 as measured by gel permeation chromatography as described above. The polysiloxane-polycarbonate can have a melt volume flow rate (often abbreviated MVR), measured at 300° C./1.2 kg, of 1 to 35 cubic centimeter per 10 minutes (cc/10 min), specifically 2 to 30 cc/10 min. Mixtures of polysiloxane-polycarbonates of different flow properties may be used to achieve the overall desired flow property.

In addition to the polycarbonates described above, the polycarbonates may be combined with a polyester. Suitable polyesters comprise repeating polyester units and may be, for example, poly(alkylene esters), liquid crystalline polyesters, and polyester copolymers. It is also possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

The polyester polymers are generally obtained through the condensation or ester interchange polymerization of the diol or diol chemical equivalent component with the diacid or diacid chemical equivalent component and having recurring units of the formula (6), wherein D represents an alkyl or cycloalkyl radical containing 2 to 12 carbon atoms and which is the residue of a straight chain, branched, or cycloaliphatic alkane diol having 2 to 12 carbon atoms or chemical equivalents thereof; and T is an alkyl, cycloaliphatic, or aryl radical which is the decarboxylated residue derived from a diacid, with the proviso that at least one of D or T is a cycloalkyl group.

Suitable polyesters are poly(alkylene esters) including poly(alkylene arylates) and poly(cycloalkylene esters). Poly(alkylene arylates) have a polyester structure according to formula (6) wherein T is a p-disubstituted arylene radical, and D is an alkylene radical. Useful esters are dicarboxylarylates include those derived from the reaction product of a dicarboxylic acid or derivative thereof wherein T is a substituted and/or unsubstituted 1,2-, 1,3-, and 1,4-phenylene; substituted and/or unsubstituted 1,4- and 1,5-naphthylenes; substituted and/or unsubstituted 1,4-cyclohexylene; and the like. Suitable alkylene radicals include those derived from the reaction product of a dihydroxy compound wherein D is a C₂₋₃₀ alkylene radical having a straight chain, branched chain, cycloalkylene, alkyl-substituted cycloalkylene, a combination comprising one or more of these, and the like. Specifically useful alkylene radicals D are bis-(alkylene-disubstituted cyclohexane), such as, for example, 1,4-(cyclohexylene)dimethylene. Suitable polyesters include poly(alkylene terephthalates), where T is 1,4-phenylene. Examples of poly(alkylene terephthalates) include poly(ethylene terephthalate) (PET), poly(1,4-butylene terephthalate) (PBT), poly(propylene terephthalate) (PPT). Also useful are poly(alkylene naphthoates), such as poly(ethylene naphthanoate) (PEN), and poly(butylene naphthanoate), (PBN). A specifically suitable poly(cycloalkylene ester) is poly(cyclohexanedimethanol terephthalate) (PCT). Combinations comprising at least one of the foregoing polyesters may also be used.

Copolymers comprising repeating ester units of the above alkylene terephthalates with other suitable repeating ester groups are specifically useful. Specifically useful ester units include different alkylene terephthalate units, which can be present in the polymer chain as individual units, or as blocks comprising multiple of the same units, i.e. blocks of specific poly(alkylene terphthalates). Specifically suitable examples of such copolymers include poly(cyclohexanedimethanol terephthalate)-co-poly(ethylene terephthalate), abbreviated as PETG where the polymer comprises greater than or equal to 50 mole % of poly(ethylene terephthalate), and abbreviated as PCTG where the polymer comprises greater than 50 mole % of poly(cyclohexanedimethanol terephthalate). It is also generally desirable that the cycloaliphatic polyesters have good melt compatibility with the tie layer composition of the tie layer. In an exemplary embodiment, it is preferred to use a cycloaliphatic polyester that displays good melt compatibility with the polycarbonate used in the tie layer.

Suitable poly(cycloalkylene esters) can include poly(alkylene cyclohexanedicarboxylates). A specific example of a useful poly(alkylene cyclohexanedicarboxylates)polyester is poly(1,4-cyclohexane-dimethanol-1,4-cyclohexanedicarboxylate) (PCCD), having recurring units of formula (15): 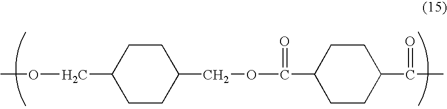
wherein, as described using formula (6), D is a dimethylene cyclohexane radical derived from cyclohexane dimethanol, and T is a cyclohexane ring derived from cyclohexanedicarboxylate or a chemical equivalent thereof and is selected from the cis- or trans-isomer or a mixture of cis- and trans-isomers thereof. PCCD, where used, is generally completely miscible with the polycarbonate.

Polyesters suitable for use herein are generally prepared by reaction of a diol with a dibasic acid or derivative. The diols useful in the preparation of the cycloaliphatic polyester polymers for use as the high quality optical sheets are straight chain, branched, or cycloaliphatic, specifically straight chain or branched alkane diols, and may contain from 2 to 12 carbon atoms.

Suitable examples of diols include ethylene glycol, propylene glycol such as 1,2- and 1,3-propylene glycol, and the like; butane diol such as 1,3- and 1,4-butane diol, and the like; diethylene glycol, 2,2-dimethyl-1,3-propane diol, 2-ethyl, 2-methyl, 1,3-propane diol, 1,3- and 1,5-pentane diol, dipropylene glycol, 2-methyl-1,5-pentane diol, 1,6-hexane diol, 1,4-cyclohexane dimethanol and particularly its cis- and trans-isomers, triethylene glycol, 1,10-decane diol, and combinations comprising at least one of the foregoing diols. Particularly preferred is dimethanol bicyclo octane, dimethanol decalin, a cycloaliphatic diol or chemical equivalents thereof, and particularly 1,4-cyclohexane dimethanol or its chemical equivalents. Where 1,4-cyclohexane dimethanol is used as the diol component, a mixture of cis- to trans-isomes in ratios of about 1:4 to about 4:1 can be used. Specifically, a ratio of cis- to trans-isomers of about 1:3 is useful.

Other diacids useful in the preparation of the polyesters may be aliphatic diacids that include carboxylic acids having two carboxyl groups each of which are attached to a saturated carbon in a saturated ring. Suitable examples of cycloaliphatic acids include decahydro naphthalene dicarboxylic acid, norbomene dicarboxylic acids, bicyclo octane dicarboxylic acids. Specifically suitable cycloaliphatic diacids include 1,4-cyclohexanedicarboxylic acid and trans-1,4-cyclohexanedicarboxylic acids. Linear aliphatic diacids are also useful provided the polyester has at least one monomer containing a cycloaliphatic ring. Illustrative examples of linear aliphatic diacids are succinic acid, adipic acid, dimethyl succinic acid, and azelaic acid. Mixtures of diacid and diols may also be used to make the cycloaliphatic polyesters.

Cyclohexanedicarboxylic acids and their chemical equivalents can be prepared, for example, by the hydrogenation of cycloaromatic diacids and corresponding derivatives such as isophthalic acid, terephthalic acid or naphthalenic acid in a suitable solvent (e.g., water or acetic acid) at room temperature and at atmospheric pressure using catalysts such as rhodium supported on a carrier comprising carbon and alumina. They may also be prepared by the use of an inert liquid medium wherein an acid is at least partially soluble under reaction conditions and a catalyst of palladium or ruthenium in carbon or silica is used.

Generally, during hydrogenation, two or more isomers are obtained in which the carboxylic acid groups are in cis- or trans-positions. The cis- and trans-isomers can be separated by crystallization with or without a solvent, for example, n-heptane, or by distillation. The cis-isomer tends to be more miscible; however, the trans-isomer has higher melting and crystallization temperatures and is generally more suitable. Mixtures of the cis- and trans-isomers may also be used, and specifically when such a mixture is used, the trans-isomer can comprise at least about 75 wt % and the cis-isomer can comprise the remainder based on the total weight of cis- and trans-isomers combined. When a mixture of isomers or more than one diacid is used, a copolyester or a mixture of two polyesters may be used.

Chemical equivalents of these diacids including esters may also be used in the preparation of the cycloaliphatic polyesters. Suitable examples of the chemical equivalents of the diacids are alkyl esters, e.g., dialkyl esters, diaryl esters, anhydrides, acid chlorides, acid bromides, and the like, as well as combinations comprising at least one of the foregoing chemical equivalents. The preferred chemical equivalents comprise the dialkyl esters of the cycloaliphatic diacids, and the most preferred chemical equivalent comprises the dimethyl ester of the acid, particularly dimethyl-trans-1,4-cyclohexanedicarboxylate.

Dimethyl-1,4-cyclohexanedicarboxylate can be obtained by ring hydrogenation of dimethylterephthalate, and two isomers having the carboxylic acid groups in the cis- and trans-positions are obtained. The isomers can be separated, the trans-isomer being specifically useful. Mixtures of the isomers may also be used as detailed above.

Poly(alkylene esters), specifically poly(cycloalkylene esters) can be prepared in the presence of a catalyst such as, for example, tetra(2-ethyl hexyl)titanate, in a suitable amount, generally about 50 to 400 ppm of titanium based upon the total weight of the final product.

The polyesters described hereinabove are generally completely miscible with the polycarbonates when blended. It is desirable for such a polyester and polycarbonate blend to have a melt volume rate of about 5 to about 150 cc/10 min., specifically about 7 to about 125 cc/10 min, more specifically about 9 to about 110 cc/10 min, and still more specifically about 10 to about 100 cc/10 min., measured at 300° C. and a load of 1.2 kilograms according to ASTM D1238-04. The above polyesters with a minor amount, e.g., from about 0.5 to about 10 percent by weight, of units derived from an aliphatic diacid and/or an aliphatic polyol to make copolyesters.

The polycarbonate and polyester may be used in ratios of 1:99 to 99:1, specifically 10:90 to 90:10, depending on the function and desired properties of the particular layer. When used as a tie layer, the polycarbonate and polyester are, respectively, used in a weight ratio of about 85:15 to about 30:70, specifically about 80:20 to about 35:65, more specifically about 75:25 to about 40:60, and still more specifically 70:30 to about 45:55.

Tie layer compositions used for making the tie layers films described herein may further include additives, which, where it is desirable to include them, may be selected by type and amount such that the inclusion of these additives does not adversely affect the desired properties of the tie layer compositions, and multilayer films and articles prepared therefrom.

The tie layer composition may include an impact modifier to increase the impact resistance. These impact modifiers include elastomer-modified graft copolymers comprising (i) an elastomeric (i.e., rubbery) polymer substrate having a Tg less than about 10° C., more specifically less than about −10° C., or more specifically about −40° to −80° C., and (ii) a rigid polymeric superstrate grafted to the elastomeric polymer substrate. As is known, elastomer-modified graft copolymers may be prepared by first providing the elastomeric polymer, then polymerizing the constituent monomer(s) of the rigid phase in the presence of the elastomer to obtain the graft copolymer. The grafts may be attached as graft branches or as shells to an elastomer core. The shell may merely physically encapsulate the core, or the shell may be partially or essentially completely grafted to the core.

Suitable materials for use as the elastomer phase include, for example, conjugated diene rubbers; copolymers of a conjugated diene with less than about 50 wt. % of a copolymerizable monomer; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl(meth)acrylates with butadiene and/or styrene; or combinations comprising at least one of the foregoing elastomers.

Suitable conjugated diene monomers for preparing the elastomer phase are of formula (16): 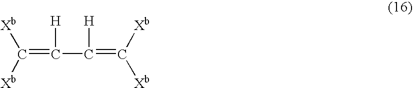
wherein each X^{b} is independently hydrogen, C₁-C₅ alkyl, or the like. Examples of conjugated diene monomers that may be used are butadiene, isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as mixtures comprising at least one of the foregoing conjugated diene monomers. Specific conjugated diene homopolymers include polybutadiene and polyisoprene.

Copolymers of a conjugated diene rubber may also be used, for example those produced by aqueous radical emulsion polymerization of a conjugated diene and one or more monomers copolymerizable therewith. Monomers that are suitable for copolymerization with the conjugated diene include monovinylaromatic monomers containing condensed aromatic ring structures, such as vinyl naphthalene, vinyl anthracene and the like, or monomers of formula (17): 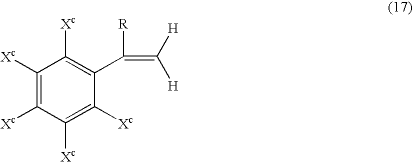
wherein each X^{c} is independently hydrogen, C₁-C₁₂ alkyl, C₃-C₁₂ cycloalkyl, C₆-C₁₂ aryl, C₇-C₁₂ aralkyl, C₇-C₁₂ alkaryl, C₁-C₁₂ alkoxy, C₃-C₁₂ cycloalkoxy, C₆-C₁₂ aryloxy, chloro, bromo, or hydroxy, and R is hydrogen, C₁-C₅ alkyl, bromo, or chloro. Examples of suitable monovinylaromatic monomers that may be used include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations comprising at least one of the foregoing compounds. Styrene and/or alpha-methylstyrene may be used as monomers copolymerizable with the conjugated diene monomer.

Other monomers that may be copolymerized with the conjugated diene are monovinylic monomers such as itaconic acid, acrylamide, N-substituted acrylamide or methacrylamide, maleic anhydride, maleimide, N-alkyl-, aryl-, or haloaryl-substituted maleimide, glycidyl(meth)acrylates, and monomers of the generic formula (18): 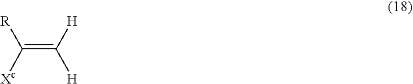
wherein R is hydrogen, C₁-C₅ alkyl, bromo, or chloro, and X^{c} is cyano, C₁-C₁₂ alkoxycarbonyl, C₁-C₁₂ aryloxycarbonyl, hydroxy carbonyl, or the like. Examples of monomers of formula (21) include acrylonitrile, ethacrylonitrile, methacrylonitrile, alpha-chloroacrylonitrile, beta-chloroacrylonitrile, alpha-bromoacrylonitrile, acrylic acid, methyl(meth)acrylate, ethyl(meth)acrylate, n-butyl(meth)acrylate, t-butyl(meth)acrylate, n-propyl(meth)acrylate, isopropyl(meth)acrylate, 2-ethylhexyl(meth)acrylate, and the like, and combinations comprising at least one of the foregoing monomers. Monomers such as n-butyl acrylate, ethyl acrylate, and 2-ethylhexyl acrylate are commonly used as monomers copolymerizable with the conjugated diene monomer. Mixtures of the foregoing monovinyl monomers and monovinylaromatic monomers may also be used.

Suitable (meth)acrylate monomers for use as the elastomeric phase may be cross-linked, particulate emulsion homopolymers or copolymers of C₁-₈ alkyl(meth)acrylates, in particular C₄₋₆ alkyl acrylates, for example n-butyl acrylate, t-butyl acrylate, n-propyl acrylate, isopropyl acrylate, 2-ethylhexyl acrylate, and the like, and combinations comprising at least one of the foregoing monomers. The C₁₋₈ alkyl(meth)acrylate monomers may optionally be polymerized in admixture with up to 15 wt. % of comonomers of formulas (16), (17), or (18). Exemplary comonomers include but are not limited to butadiene, isoprene, styrene, methyl methacrylate, phenyl methacrylate, penethylmethacrylate, N-cyclohexylacrylamide, vinyl methyl ether or acrylonitrile, and mixtures comprising at least one of the foregoing comonomers. Optionally, up to 5 wt. % a polyfunctional crosslinking comonomer may be present, for example divinylbenzene, alkylenediol di(meth)acrylates such as glycol bisacrylate, alkylenetriol tri(meth)acrylates, polyester di(meth)acrylates, bisacrylamides, triallyl cyanurate, triallyl isocyanurate, allyl(meth)acrylate, diallyl maleate, diallyl fumarate, diallyl adipate, triallyl esters of citric acid, triallyl esters of phosphoric acid, and the like, as well as combinations comprising at least one of the foregoing crosslinking agents.

The elastomer phase may be polymerized by mass, emulsion, suspension, solution or combined processes such as bulk-suspension, emulsion-bulk, bulk-solution or other techniques, using continuous, semibatch, or batch processes. The particle size of the elastomer substrate is not critical. For example, an average particle size of about 0.001 to about 25 micrometers, specifically about 0.01 to about 15 micrometers, or even more specifically about 0.1 to about 8 micrometers may be used for emulsion based polymerized rubber lattices. A particle size of about 0.5 to about 10 micrometers, specifically about 0.6 to about 1.5 micrometers may be used for bulk polymerized rubber substrates. Particle size may be measured by simple light transmission methods or capillary hydrodynamic chromatography (CHDF). The elastomer phase may be a particulate, moderately cross-linked conjugated butadiene or C₄₋₆ alkyl acrylate rubber, and specifically has a gel content greater than 70%. Also suitable are mixtures of butadiene with styrene and/or C₄₋₆ alkyl acrylate rubbers.

The elastomeric phase may provide about 5 to about 95 wt. % of the total graft copolymer, more specifically about 20 to about 90 wt. %, and even more specifically about 40 to about 85 wt. % of the elastomer-modified graft copolymer, the remainder being the rigid graft phase.

The rigid phase of the elastomer-modified graft copolymer may be formed by graft polymerization of a mixture comprising a monovinylaromatic monomer and optionally one or more comonomers in the presence of one or more elastomeric polymer substrates. The above-described monovinylaromatic monomers of formula (17) may be used in the rigid graft phase, including styrene, alpha-methyl styrene, halostyrenes such as dibromostyrene, vinyltoluene, vinylxylene, butylstyrene, para-hydroxystyrene, methoxystyrene, or the like, or combinations comprising at least one of the foregoing monovinylaromatic monomers. Suitable comonomers include, for example, the above-described monovinylic monomers and/or monomers of the general formula (21). In one embodiment, R is hydrogen or C₁-C₂ alkyl, and X^{c} is cyano or C₁-C₁₂ alkoxycarbonyl. Specific examples of suitable comonomers for use in the rigid phase include acrylonitrile, ethacrylonitrile, methacrylonitrile, methyl(meth)acrylate, ethyl(meth)acrylate, n-propyl (meth)acrylate, isopropyl(meth)acrylate, and the like, and combinations comprising at least one of the foregoing comonomers.

The relative ratio of monovinylaromatic monomer and comonomer in the rigid graft phase may vary widely depending on the type of elastomer substrate, type of monovinylaromatic monomer(s), type of comonomer(s), and the desired properties of the impact modifier. The rigid phase may generally comprise up to 100 wt. % of monovinyl aromatic monomer, specifically about 30 to about 100 wt. %, more specifically about 50 to about 90 wt. % monovinylaromatic monomer, with the balance being comonomer(s).

Depending on the amount of elastomer-modified polymer present, a separate matrix or continuous phase of ungrafted rigid polymer or copolymer may be simultaneously obtained along with the elastomer-modified graft copolymer. Typically, such impact modifiers comprise about 40 to about 95 wt. % elastomer-modified graft copolymer and about 5 to about 65 wt. % graft (co)polymer, based on the total weight of the impact modifier. In another embodiment, such impact modifiers comprise about 50 to about 85 wt. %, more specifically about 75 to about 85 wt. % rubber-modified graft copolymer, together with about 15 to about 50 wt. %, more specifically about 15 to about 25 wt. % graft (co)polymer, based on the total weight of the impact modifier.

Another specific type of elastomer-modified impact modifier comprises structural units derived from at least one silicone rubber monomer, a branched acrylate rubber monomer having the formula H₂C═C(R^{d})C(O)OCH₂CH₂R^{e}, wherein R^{d} is hydrogen or a C₁-C₈ linear or branched alkyl group and Re is a branched C₃-C₁₆ alkyl group; a first graft link monomer; a polymerizable alkenyl-containing organic material; and a second graft link monomer. The silicone rubber monomer may comprise, for example, a cyclic siloxane, tetraalkoxysilane, trialkoxysilane, (acryloxy)alkoxysilane, (mercaptoalkyl)alkoxysilane, vinylalkoxysilane, or allylalkoxysilane, alone or in combination, e.g., decamethylcyclopentasiloxane, dodecamethylcyclohexasiloxane, trimethyltriphenylcyclotrisiloxane, tetramethyltetraphenylcyclotetrasiloxane, tetramethyltetravinylcyclotetrasiloxane, octaphenylcyclotetrasiloxane, octamethylcyclotetrasiloxane and/or tetraethoxysilane.

Exemplary branched acrylate rubber monomers include iso-octyl acrylate, 6-methyloctyl acrylate, 7-methyloctyl acrylate, 6-methylheptyl acrylate, and the like, alone or in combination. The polymerizable alkenyl-containing organic material may be, for example, a monomer of formula (17) or (18), e.g., styrene, alpha-methylstyrene, acrylonitrile, methacrylonitrile, or an unbranched (meth)acrylate such as methyl methacrylate, 2-ethylhexyl methacrylate, methyl acrylate, ethyl acrylate, n-propyl acrylate, or the like, alone or in combination.

The at least one first graft link monomer may be an (acryloxy)alkoxysilane, a (mercaptoalkyl)alkoxysilane, a vinylalkoxysilane, or an allylalkoxysilane, alone or in combination, e.g., (gamma-methacryloxypropyl)(dimethoxy)methylsilane and/or (3-mercaptopropyl)trimethoxysilane. The at least one second graft link monomer is a polyethylenically unsaturated compound having at least one allyl group, such as allyl methacrylate, triallyl cyanurate, or triallyl isocyanurate, alone or in combination.

The silicone-acrylate impact modifier compositions can be prepared by emulsion polymerization, wherein, for example at least one silicone rubber monomer is reacted with at least one first graft link monomer at a temperature from about 30° C. to about 110° C. to form a silicone rubber latex, in the presence of a surfactant such as dodecylbenzenesulfonic acid. Alternatively, a cyclic siloxane such as cyclooctamethyltetrasiloxane and an tetraethoxyorthosilicate may be reacted with a first graft link monomer such as (gamma-methacryloxypropyl)methyldimethoxysilane, to afford silicone rubber having an average particle size from about 100 nanometers to about 2 microns. At least one branched acrylate rubber monomer is then polymerized with the silicone rubber particles, optionally in presence of a cross linking monomer, such as allylmethacrylate in the presence of a free radical generating polymerization catalyst such as benzoyl peroxide. This latex is then reacted with a polymerizable alkenyl-containing organic material and a second graft link monomer. The latex particles of the graft silicone-acrylate rubber hybrid may be separated from the aqueous phase through coagulation (by treatment with a coagulant) and dried to a fine powder to produce the silicone-acrylate rubber impact modifier composition. This method can be generally used for producing the silicone-acrylate impact modifier having a particle size from about 100 nanometers to about two micrometers.

Processes known for the formation of the foregoing elastomer-modified graft copolymers include mass, emulsion, suspension, and solution processes, or combined processes such as bulk-suspension, emulsion-bulk, bulk-solution or other techniques, using continuous, semibatch, or batch processes.

In one embodiment the foregoing types of impact modifiers are prepared by an emulsion polymerization process that is free of basic materials such as alkali metal salts of C₆₋₃₀ fatty acids, for example sodium stearate, lithium stearate, sodium oleate, potassium oleate, and the like, alkali metal carbonates, amines such as dodecyl dimethyl amine, dodecyl amine, and the like, and ammonium salts of amines. Such materials are commonly used as surfactants in emulsion polymerization, and may catalyze transesterification and/or degradation of polycarbonates. Instead, ionic sulfate, sulfonate or phosphate surfactants may be used in preparing the impact modifiers, particularly the elastomeric substrate portion of the impact modifiers. Suitable surfactants include, for example, C₁₋₂₂ alkyl or C₇₋₂₅ alkylaryl sulfonates, C₁₋₂₂ alkyl or C₇₋₂₅ alkylaryl sulfates, C₁₋₂₂ alkyl or C₇₋₂₅ alkylaryl phosphates, substituted silicates, and mixtures thereof. A specific surfactant is a C₆₋₁₆, specifically a C₈₋₁₂ alkyl sulfonate. In the practice, any of the above-described impact modifiers may be used providing it is free of the alkali metal salts of fatty acids, alkali metal carbonates and other basic materials.

A specific impact modifier of this type is an MBS impact modifier wherein the butadiene substrate is prepared using above-described sulfonates, sulfates, or phosphates as surfactants. It is also preferred that the impact modifier have a pH of about 3 to about 8, specifically about 4 to about 7. Impact modifiers, where used, are generally present in amounts of about 0.5 to about 50 percent by weight, based on 100 percent by weight of the polycarbonate and poly(alkylene ester).

The tie layer composition may further comprise fillers. Suitable fillers or reinforcing agents include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

Specifically, useful fillers possess shape and dimensional qualities suitable to the reflection and/or refraction of light. Reflective and/or refractive fillers i.e., fillers having light-reflecting properties include those having planar facets, and can be multifaceted or in the form of flakes, shards, plates, leaves, wafers, and the like. The shape can be irregular or regular. A non-limiting example of a regular shape is a hexagonal plate. Specifically suitable reflective and/or refractive fillers are two dimensional, plate-type fillers, wherein a particle of a plate type filler has a ratio of its largest dimension to smallest dimension of greater than or equal to about 3:1, specifically greater than or equal to about 5:1, and more specifically greater than or equal to about 10:1. The largest dimension so defined can also be referred to as the diameter of the particle. Plate-type fillers have a distribution of particle diameters described by an upper limit and a lower limit. The lower limit is described by the lower detection limit of the method used to determine particle diameter, and corresponds to it. An example of a suitable method for determining particle diameter is laser light scattering. The upper limit may be less than or equal to about 1000 micrometers, specifically less than or equal to about 750 micrometers, and more specifically less than or equal to about 500 micrometers. The plate type filler thus has a distribution of particle diameters, where the distribution can be unimodal, bimodal, or multimodal. The diameter can be described generally by the mean of the distribution of the particle diameters, i.e., the mean diameter. Specifically, particles suitable for use herein may have a mean diameter of about 1 to about 100 micrometers, specifically about 5 to 75 micrometers, and more specifically about 10 to about 60 micrometers. Specific reflective fillers are further of a composition having surface exterior finish useful for reflecting incident light. Metallic reflective fillers such as those based on aluminum, silver, copper, bronze, steel, brass, gold, tin, silicon, alloys of these, combinations comprising at least one of the foregoing metals, and the like, are specifically useful. Also specifically useful are mineral reflective fillers prepared from a composition presenting a surface that is useful for reflecting and/or refracting incident light. Mineral fillers having reflecting and/or refracting properties suitable for use herein include micas, alumina, lamellar talc, silica, silicon carbide, glass, combinations comprising at least one of the foregoing mineral fillers, and the like.

The above fillers can be coated with, for example, metallic coatings and/or silane coatings, to improve reflectivity, or increase compatibility with and adhesion to the polycarbonate.

The fillers, including reflective fillers, can be used in the tie layer composition in an amount of about 0.01 to about 25 percent by weight, specifically about 0.05 to about 10 percent by weight, and more specifically about 0.1 to about 5 percent by weight, per 100 percent by weight of the polycarbonate and poly(alkylene ester).

The tie layer composition may further comprise antioxidant additives. Suitable antioxidant additives include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants are generally used in amounts of 0.0001 to 1 percent by weight, based on 100 percent by weight of the polycarbonate and poly(alkylene ester).

The tie layer composition may further comprise heat stabilizers. Suitable heat stabilizer additives include, for example, organophosphites such as triphenyl phosphite, tris-(2,6-dimethylphenyl)phosphite, tris-(mixed mono-and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers are generally used in amounts of 0.0001 to 1 percent by weight, based on 100 percent by weight of the polycarbonate and poly(alkylene ester).

The tie layer composition may further comprise light stabilizers and/or ultraviolet light (UV) absorbing additives. Where used, suitable light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers. Light stabilizers are generally used in amounts of 0.0001 to 1 percent by weight, based on 100 percent by weight of the polycarbonate and poly(alkylene ester).

Suitable UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenylacryloyl)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than about 100 nanometers; or the like, or combinations comprising at least one of the foregoing UV absorbers. UV absorbers are generally used in amounts of 0.0001 to about 1 percent by weight, based on 100 percent by weight of the polycarbonate and poly(alkylene ester).

Plasticizers, lubricants, and/or mold release agents additives may also be used in the tie layer composition. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates suc as resorcinol tetraphenyl diphosphate (RDP), the bis(diphenyl)phosphate of hydroquinone and the bis(diphenyl)phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like. Such materials are generally used in amounts of 0.0001 to 1 percent by weight, based on 100 percent by weight of the polycarbonate and poly(alkylene ester).

The tie layer composition may further comprise an antistatic agent. The term “antistatic agent” refers to monomeric, oligomeric, or polymeric materials that can be processed into polymer resins and/or sprayed onto materials or articles to improve conductive properties and overall physical performance. Examples of monomeric antistatic agents include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents include certain polyesteramides polyether-polyamide(polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example PELESTAT™ 6321 (Sanyo) or PEBAX™ MH1657 (Atofina), IRGASTAT™ P18 and P22 (Ciba-Geigy). Other polymeric materials that may be used as antistatic agents are inherently conducting polymers such as polyaniline (commercially available as PANIPOL® EB from Panipol), polypyrrole and polythiophene (commercially available from Bayer), which retain some of their intrinsic conductivity after melt processing at elevated temperatures. In one embodiment, carbon fibers, carbon nanofibers, carbon nanotubes, carbon black, or any combination of the foregoing may be used in a polymeric resin containing chemical antistatic agents to render the composition electrostatically dissipative. Antistatic agents are generally used in amounts of 0.0001 to 5 percent by weight, based on 100 percent by weight of the polycarbonate and poly(alkylene ester).

Colorants such as pigment and/or dye additives may also be present in the tie layer composition. Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations comprising at least one of the foregoing pigments. Pigments are generally used in amounts of 0.01 to 10 percent by weight, based on 100 percent by weight of the polycarbonate and poly(alkylene ester).

Suitable dyes are generally organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly(C₂₋₈)olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene; chrysene; rubrene; coronene, or the like, or combinations comprising at least one of the foregoing dyes. Dyes are generally used in amounts of 0.01 to 10 percent by weight, based on 100 percent by weight of the polycarbonate and poly(alkylene ester).

The tie layer composition may further comprise flame retardants. Suitable flame retardant that may be added may be organic compounds that include phosphorus, bromine, and/or chlorine. Non-brominated and non-chlorinated phosphorus-containing flame retardants may be preferred in certain applications for regulatory reasons, for example organic phosphates and organic compounds containing phosphorus-nitrogen bonds.

One type of exemplary organic phosphate is an aromatic phosphate of the formula (GO)₃P═O, wherein each G is independently an alkyl, cycloalkyl, aryl, alkaryl, or aralkyl group, provided that at least one G is an aromatic group. Two of the G groups may be joined together to provide a cyclic group, for example, diphenyl pentaerythritol diphosphate. Other suitable aromatic phosphates may be, for example, phenyl bis(dodecyl)phosphate, phenyl bis(neopentyl)phosphate, phenyl bis(3,5,5′-trimethylhexyl)phosphate, ethyl diphenyl phosphate, 2-ethylhexyl di(p-tolyl)phosphate, bis(2-ethylhexyl)p-tolyl phosphate, tritolyl phosphate, bis(2-ethylhexyl)phenyl phosphate, tri(nonylphenyl)phosphate, bis(dodecyl)p-tolyl phosphate, dibutyl phenyl phosphate, 2-chloroethyl diphenyl phosphate, p-tolyl bis(2,5,5′-trimethylhexyl)phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like.

Di- or polyfunctional aromatic phosphorus-containing compounds are also useful, for example, compounds of the formulas below: 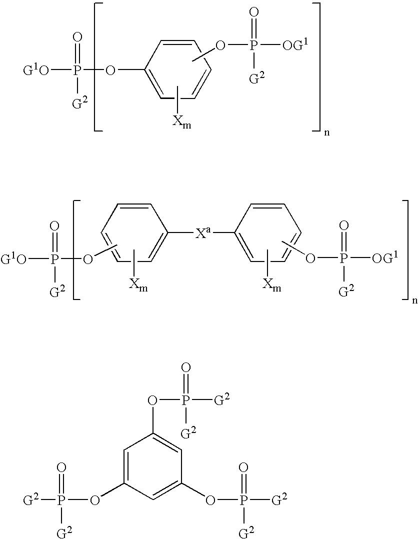
wherein each G¹ is independently a hydrocarbon having 1 to about 30 carbon atoms; each G² is independently a hydrocarbon or hydrocarbonoxy having 1 to about 30 carbon atoms; each X is independently a bromine or chlorine; m is 0 to 4, and n is 1 to about 30. Examples of suitable di- or polyfunctional aromatic phosphorus-containing compounds include resorcinol tetraphenyl diphosphate (RDP), the bis(diphenyl)phosphate of hydroquinone and the bis(diphenyl) phosphate of bisphenol-A, respectively, their oligomeric and polymeric counterparts, and the like.

Exemplary suitable flame retardant compounds containing phosphorus-nitrogen bonds include phosphonitrilic chloride, phosphorus ester amides, phosphoric acid amides, phosphonic acid amides, phosphinic acid amides, tris(aziridinyl)phosphine oxide. When present, phosphorus-containing flame retardants are generally present in amounts of 0.1 to 5 percent by weight, based on 100 percent by weight of the polycarbonate and poly(alkylene ester).

Halogenated materials may also be used as flame retardants, for example halogenated compounds and resins having formula (19): 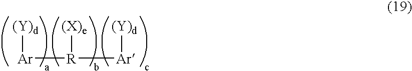
wherein R is an alkylene, alkylidene or cycloaliphatic linkage, e.g., methylene, ethylene, propylene, isopropylene, isopropylidene, butylene, isobutylene, amylene, cyclohexylene, cyclopentylidene, or the like; or an oxygen ether, carbonyl, amine, or a sulfur containing linkage, e.g., sulfide, sulfoxide, sulfone, or the like. R can also consist of two or more alkylene or alkylidene linkages connected by such groups as aromatic, amino, ether, carbonyl, sulfide, sulfoxide, sulfone, or the like.

Ar and Ar′ in formula (19) are each independently mono- or polycarbocyclic aromatic groups such as phenylene, biphenylene, terphenylene, naphthylene, or the like.

Y is an organic, inorganic, or organometallic radical, for example: halogen, e.g., chlorine, bromine, iodine, fluorine; or ether groups of the general formula OE, wherein E is a monovalent hydrocarbon radical similar to X; or monovalent hydrocarbon groups of the type represented by R; or other substituents, e.g., nitro, cyano, and the like, said substituents being essentially inert provided that there is at least one and specifically two halogen atoms per aryl nucleus.

When present, each X is independently a monovalent hydrocarbon group, for example an alkyl group such as methyl, ethyl, propyl, isopropyl, butyl, decyl, or the like; an aryl groups such as phenyl, naphthyl, biphenyl, xylyl, tolyl, or the like; and aralkyl group such as benzyl, ethylphenyl, or the like; a cycloaliphatic group such as cyclopentyl, cyclohexyl, or the like. The monovalent hydrocarbon group may itself contain inert substituents.

Each d is independently 1 to a maximum equivalent to the number of replaceable hydrogens substituted on the aromatic rings comprising Ar or Ar′. Each e is independently 0 to a maximum equivalent to the number of replaceable hydrogens on R. Each a, b, and c is independently a whole number, including 0. When b is not 0, neither a nor c may be 0. Otherwise either a or c, but not both, may be 0. Where b is 0, the aromatic groups are joined by a direct carbon-carbon bond.

The hydroxyl and Y substituents on the aromatic groups, Ar and Ar′ can be varied in the ortho, meta or para positions on the aromatic rings and the groups can be in any possible geometric relationship with respect to one another.

Included within the scope of the above formula are bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; and 2,2-bis-(3,5-dichloro-4-hydroxyphenyl)-propane 2,2 bis-(3-bromo-4-hydroxyphenyl)-propane. Also included within the above structural formula are: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

Also useful are oligomeric and polymeric halogenated aromatic compounds, such as a copolycarbonate of bisphenol A and tetrabromobisphenol A and a carbonate precursor, e.g., phosgene. Metal synergists, e.g., antimony oxide, may also be used with the flame retardant. When present, halogen containing flame retardants are generally present in amounts of 0.1 to 10 percent by weight, based on 100 percent by weight of the polycarbonate and poly(alkylene ester).

Inorganic flame retardants may also be used, for example salts of C₂₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate, and the like; salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complex such as Li₃AlF₆, BaSiF₆, KBF₄, K₃AlF₆, KAlF₄, K₂SiF₆, and/or Na₃AlF₆ or the like. When present, inorganic flame retardant salts are generally present in amounts of 0.1 to 5 percent by weight, based on 100 percent by weight of the polycarbonate and poly(alkylene ester).

Anti-drip agents may also be used in the tie layer composition, for example a fibril forming or non-fibril forming fluoropolymer such as polytetrafluoroethylene (PTFE). The anti-drip agent may be encapsulated by a rigid copolymer as described above, for example styrene-acrylonitrile copolymer (SAN). PTFE encapsulated in SAN is known as TSAN. Encapsulated fluoropolymers may be made by polymerizing the encapsulating polymer in the presence of the fluoropolymer, for example an aqueous dispersion. TSAN may provide significant advantages over PTFE, in that TSAN may be more readily dispersed in the composition. A suitable TSAN may comprise, for example, about 50 wt. % PTFE and about 50 wt. % SAN, based on the total weight of the encapsulated fluoropolymer. The SAN may comprise, for example, about 75 wt. % styrene and about 25 wt. % acrylonitrile based on the total weight of the copolymer. Alternatively, the fluoropolymer may be pre-blended in some manner with a second polymer, such as for, example, an aromatic polycarbonate resin or SAN to form an agglomerated material for use as an anti-drip agent. Either method may be used to produce an encapsulated fluoropolymer. Antidrip agents are generally used in amounts of 0.1 to 5 percent by weight, based on 100 percent by weight of the polycarbonate and poly(alkylene ester).

Radiation stabilizers may also be present in the tie layer composition, specifically gamma-radiation stabilizers. Suitable gamma-radiation stabilizers include diols, such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; alicyclic alcohols such as 1,2-cyclopentanediol, 1,2-cyclohexanediol, and the like; branched acyclic diols such as 2,3-dimethyl-2,3-butanediol (pinacol), and the like, and polyols, as well as alkoxy-substituted cyclic or acyclic alkanes. Alkenols, with sites of unsaturation, are also a useful class of alcohols, examples of which include 4-methyl-4-penten-2-ol, 3-methyl-pentene-3-ol, 2-methyl-4-penten-2-ol, 2,4-dimethyl-4-pene-2-ol, and 9-decen-1-ol. Another class of suitable alcohols is the tertiary alcohols, which have at least one hydroxy substituted tertiary carbon. Examples of these include 2-methyl-2,4-pentanediol (hexylene glycol), 2-phenyl-2-butanol, 3-hydroxy-3-methyl-2-butanone, 2-phenyl-2-butanol, and the like, and cycoloaliphatic tertiary carbons such as 1-hydroxy-1-methyl-cyclohexane. Another class of suitable alcohols is hydroxymethyl aromatics, which have hydroxy substitution on a saturated carbon attached to an unsaturated carbon in an aromatic ring. The hydroxy substituted saturated carbon may be a methylol group (—CH₂OH) or it may be a member of a more complex hydrocarbon group such as would be the case with (—CR⁴HOH) or (—CR₂⁴OH) wherein R⁴ is a complex or a simply hydrocarbon. Specific hydroxy methyl aromatics may be benzhydrol, 1,3-benzenedimethanol, benzyl alcohol, 4-benzyloxy benzyl alcohol and benzyl benzyl alcohol. Specific alcohols are 2-methyl-2,4-pentanediol (also known as hexylene glycol), polyethylene glycol, polypropylene glycol. Gamma-radiation stabilizing compounds are typically used in amounts of 0.001 to 1 wt %, more specifically 0.01 to 0.5 wt %, based on the total weight of the polycarbonate and poly(alkylene ester).

In an embodiment, the tie layer composition comprises a polycarbonate and a poly(alkylene ester) present in a weight ratio of about 85:15 to about 30:70, specifically about 80:20 to about 35:65, more specifically about 75:25 to about 40:60, and still more specifically about 70:30 to about 40:60. The tie layer composition may further comprise additives including impact modifiers, fillers, flame retardants, anti-drip agents, plasticizers, UV stabilizers, thermal stabilizers, plasticizers, antistatic additives, colorants, gamma-ray stabilizers, a combination comprising at least one of the foregoing, and the like, where the inclusion of such additives does not adversely affect desirable properties of the tie layer composition. Where additives are included and unless otherwise specified, the combined weights of the polycarbonate and poly(alkylene ester), with the combined weight percentages of all specified components, may not exceed 100 wt % of the tie layer composition.

The tie layer compositions for use in preparing tie layers for multilayer films may be manufactured by methods generally available in the art. For example, in one embodiment, in one manner of proceeding, a powdered polycarbonate resin and any other components are first blended in a HENSCHEL-Mixer® high speed mixer. Other low shear processes including but not limited to hand mixing may also accomplish this blending. The blend is then fed into the throat of a twin-screw extruder via a hopper. Alternatively, one or more of the components may be incorporated into the composition by feeding directly into the extruder at the throat and/or downstream through a sidestuffer. Such additives may also be compounded into a masterbatch with a desired polymeric resin and fed into the extruder. The additives may be added to the polycarbonate base material to make a concentrate, before this is added to the final product. The extruder is generally operated at a temperature higher than that necessary to cause the composition to flow, typically about 400° F. (204° C.) to about 650° F. (343° C.). The extrudate is immediately quenched in a water batch and pelletized. The pellets, prepared by cutting the extrudate, may be about one-fourth inch long or less as desired. Such pellets may be used for subsequent extrusion, casting, molding, shaping, or forming of layers, where the layers can be used in a multilayer film.

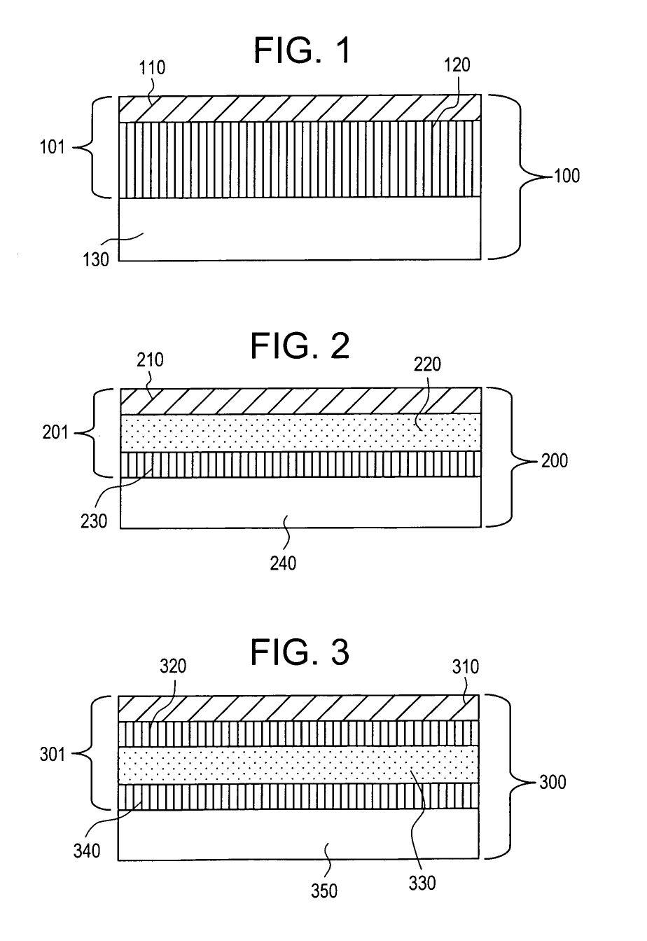

The foregoing compositions are used to form articles comprising multilayer films and substrates. An exemplary embodiment of an article 100 is shown in FIG. 1. FIG. 1 depicts a multilayer film 101 having a superstrate layer 110, a substrate 130, and a tie layer 120 comprising the polycarbonate disposed therebetween. As used herein “disposed” means in at least partial contact with. In a specific embodiment, tie layer 120 comprises colorant and/or filler to provide optical effect for the multilayer film.

The tie layer comprises a tie layer composition comprising a polycarbonate and poly(alkylene ester), as described above. The tie layer is disposed between and in at least partial contact a superstrate and a substrate, each of which can possess surface properties different from one another. The superstrates and substrates can comprise dissimilar compositions. The tie layer is specifically useful for providing desirable surface adhesion properties between the tie layer and each adjacent layer, specifically where the adjacent layers may have poor adhesion to each other when contacted to each other directly. In one specific embodiment, the polycarbonate is bisphenol-A polycarbonate. In another specific embodiment, the poly(alkylene ester) is poly(1,4-cyclohexanedimethylene-1,4-cyclohexanedicarboxylate), poly((1,4-cyclohexanedimethylene terephthalate)-co-(1,2-ethylene terephthalate)) having less than or equal to 50 wt % of 1,4-cyclohexanedimethylene terephthalate ester units; poly((1,4-cyclohexanedimethylene terephthalate)-co-(1,2-ethylene terephthalate)) having greater than 50 wt % of 1,4-cyclohexanedimethylene terephthalate ester units; or a combination comprising one or more of the foregoing poly(alkylene esters).

The article can comprise a substrate, also referred to herein as a substrate layer. The substrate can be any surface to which the multilayer film is contacted. Specifically, the substrate can be a surface that provides a structural backing to the multilayer film.

The substrate in the articles of this invention may comprise a material selected from the group consisting of a thermoplastic resin, a thermoset resin, a metal, a ceramic, a glass, a cellulosic material, and a combination comprising one or more of these. There is no particular limitation on the thickness of the substrate layer provided that an article comprising the multilayer film and substrate can be processed into a final desired form. In an embodiment, the substrate is a polymer substrate comprising a thermoplastic polymer. Thermoplastic polymers include, but are not limited to, polycarbonates, particularly aromatic polycarbonates, polyurethanes, polyacetals, polyarylene ethers, polyphenylene ethers, polyarylene sulfides, polyphenylene sulfides, polyimides, polyamideimides, polyetherimides, polyetherketones, polyaryletherketones, polyetheretherketones, polyetherketoneketones, polyamides, polyesters, liquid crystalline polyesters, polyetheresters, polyetheramides, polyesteramides, and polyester-polycarbonates (other than those employed for the layers of the multilayer film, as defined herein). A substrate layer may contain additives including, but not limited to, colorants, pigments, dyes, impact modifiers, stabilizers, color stabilizers, heat stabilizers, light stabilizers, UV screeners, UV absorbers, flame retardants, anti-drip agents, fillers, flow aids, plasticizers, ester interchange inhibitors, antistatic agents, and mold release agents, as described hereinabove.

Suitable substrate polycarbonates (sometimes referred to hereinafter as “PC”) can be polycarbonates or polyester-polycarbonates as described hereinabove. In a specific embodiment, the polycarbonate can be a bisphenol A polycarbonate homopolymer and/or copolymer. The weight average molecular weight (Mw) of a substrate polycarbonate may be about 5,000 to about 100,000; specifically 25,000 to about 65,000, as determined using GPC as described hereinabove.

Polyester substrates can include polyesters such as those described hereinabove. Specifically suitable polyesters include, but are not limited to, poly(alkylene dicarboxylates), specifically poly(ethylene terephthalate) (sometimes referred to hereinafter as “PET”), poly(1,4-butylene terephthalate) (sometimes referred to hereinafter as “PBT”), poly(trimethylene terephthalate), poly(ethylene naphthalate), poly(butylene naphthalate), poly(cyclohexanedimethanol terephthalate), poly(cyclohexanedimethanol-co-ethylene terephthalate), and poly(1,4-cyclohexanedimethyl-1,4-cyclohexanedicarboxylate). Also included are polyarylates, examples of which include those comprising structural units derived from bisphenol A, terephthalic acid, and isophthalic acid.

Polyurethane substrates can include long fiber injection polyurethane (LFI-PU) foam, and reactive injection molded polyurethane foam (RIM-PU). Suitable polyurethane substrates comprise urethane repeating units. Aromatic, aliphatic, cycloaliphatic, or mixed aliphatic and cycloaliphatic urethane repeating units may be used. Urethanes are typically prepared by the condensation of a diisocyanate with a diol. The diisocyanate and diol used to prepare the urethane can comprise divalent aromatic, aliphatic, aliphatic and aromatic, groups that may be the same or different. The divalent units can also be C₆ to C₃₀, specifically C₆ to C₂₅, more specifically C₆ to C₂₀ aromatic groups, including substituted and unsubstituted aromatic, and the like.

The aliphatic polyisocyanate component contains about 4 to 20 carbon atoms. Exemplary aliphatic polyisocyanates include isophorone diisocyanate; dicyclohexylmethane-4,4′-diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,9-nonamethylene diisocyanate; 1,10-decamethylene diisocyanate; 2,2,4-trimethyl-1,5-pentamethylene diisocyanate; 2,2′-dimethyl-1,5-pentamethylene diisocyanate; 3-methoxy-1,6-hexamethylene diisocyanate; 3-butoxy-1,6-hexamethylene diisocyanate; omega, omega′-dipropylether diisocyanate; 1,4-cyclohexyl diisocyanate; 1,3-cyclohexyl diisocyanate; trimethylhexamethylene diisocyanate; and combinations comprising at least one of the foregoing. Suitable aromatic polyisocyanates include toluene diisocyanate, methylene bis-phenylisocyanate(diphenylmethane diisocyanate), methylene bis-cyclohexylisocyanate(hydrogenated MDI), naphthalene diisocyanate, and the like.

Suitable diols may include aromatic dihydroxy compounds according to Formulas 4 and 7 and as described herein, and diols such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; alicyclic alcohols such as 1,2-cyclopentanediol, 1,2-cyclohexanediol, and the like; branched acyclic diols such as 2,3-dimethyl-2,3-butanediol (pinacol), 1,4-dimethylol cyclohexane, and the like, and polyols. Polyether and/or polyester urethanes include the reaction product of an aliphatic polyether or polyester polyol with an aliphatic or aromatic polyisocyanate can also be used. The polyether polyol can be based on a straight chained or branched alkylene oxide of from one to about twelve carbon atoms. Suitable polyurethanes for use herein include, for example, polyurethanes comprising poly(diphenylmethane diisocyanate) and polyether polyols, such as BAYDUR® 263 IMR and 246 IMR polyurethanes, or polyurethanes containing polyols such as BAYDUR® 600 and 700 series polyurethanes (with or without blowing agents), from Bayer Corporation. In a specific embodiment, the polyurethane is a foam.

Suitable addition polymer substrates can include homo- and copolymeric aliphatic olefin and functionalized olefin polymers, which are homopolymers and copolymers comprising structural units derived from aliphatic olefins or functionalized olefins or both, and their alloys or blends. Illustrative examples can include, but are not limited to, polyethylene, polypropylene, thermoplastic polyolefin (TPO), ethylene-propylene copolymer, poly(vinyl chloride), poly(vinyl chloride-co-vinylidene chloride), poly(vinyl fluoride), poly(vinylidene fluoride), poly(vinyl acetate), poly(vinyl alcohol), poly(vinyl butyral), poly(acrylonitrile), acrylic polymers such as those of (meth)acrylamides or of alkyl(meth)acrylates such as poly(methyl methacrylate) (PMMA), and polymers of alkenylaromatic compounds such as polystyrenes, including syndiotactic polystyrene. In some embodiments addition polymer substrates are polystyrenes and especially the so-called acrylonitrile-butadiene-styrene (ABS) and acrylonitrile-styrene-acrylate (ASA) copolymers, which may contain thermoplastic, non-elastomeric styrene-acrylonitrile side chains grafted on an elastomeric base polymer of butadiene and alkyl acrylate, respectively.

Blends of any of the foregoing polymers may also be employed as substrates. Typical blends can include, but are not limited to, those comprising PC/ABS, PC/ASA, PC/PBT, PC/PET, PC/polyetherimide, PC/polysulfone, polyester/polyetherimide, PMMA/acrylic rubber, polyphenylene ether-polystyrene, polyphenylene ether-polypropylene, polyphenylene ether-polyamide or polyphenylene ether-polyester. Although the substrate layer may incorporate other thermoplastic polymers, the above-described polycarbonates and/or addition polymers often constitute the major proportion thereof.

The substrate layer may also comprise a cured, uncured or at partially cured thermoset resin, wherein the use of the term “thermoset resin” in the present context refers to any of these options. Suitable thermoset resin substrates include, but are not limited to, those derived from epoxys, cyanate esters, unsaturated polyesters, diallylphthalate, acrylics, alkyds, phenol-formaldehyde, novolacs, resoles, bismaleimides, PMR resins, melamine-formaldehyde, urea-formaldehyde, benzocyclobutanes, hydroxymethylfurans, and isocyanates. The thermoset resin substrate may further comprise, for example, a thermoplastic polymer including, but not limited to, polyphenylene ether, polyphenylene sulfide, polysulfone, polyetherimide, or polyester. The thermoplastic polymer can be combined with thermoset monomer mixture prior to curing of the thermoset.

A thermoplastic or thermoset substrate layer can include a colorant and/or filler as disclosed hereinabove. Illustrative extending and reinforcing fillers, and colorants include silica, silicates, zeolites, titanium dioxide, stone powder, glass fibers, glass rovings, glass spheres, carbon fibers, carbon black, graphite, calcium carbonate, talc, mica, lithopone, zinc oxide, zirconium silicate, iron oxides, diatomaceous earth, calcium carbonate, magnesium oxide, chromic oxide, zirconium oxide, aluminum oxide, crushed quartz, calcined clay, talc, kaolin, asbestos, cellulose, wood flour, cork, cotton and synthetic textile fibers, especially reinforcing fillers such as glass fibers, carbon fibers, and metal fibers, as well as colorants such as metal flakes, glass flakes and beads, ceramic particles, other polymer particles, dyes and pigments which may be organic, inorganic or organometallic.

The substrate layer may also comprise a cellulosic material including, such as, for example, but not limited to, wood, paper, cardboard, fiber board, particle board, plywood, construction paper, Kraft paper, cellulose nitrate, cellulose acetate butyrate, and like cellulosic-containing materials. Blends of a cellulosic material and either a thermoset resin (such as an adhesive), a thermoplastic polymer (particularly a recycled thermoplastic polymer, such as PET or polycarbonate), or a mixture comprising a thermoset resin and a thermoplastic polymer, may be used. In an embodiment, a suitable substrate may comprise, for example, a RIM or LFI (long fiber injection) molded polyurethane reinforced with glass in the form of fibers or rovings.

As shown in FIG. 1, in one embodiment, the superstrate 110 is a single layer which forms the outer surface of multilayer film 100. In this embodiment the superstrate is disposed on and in intimate contact with the tie layer, and functions as a surface layer. The tie layer in this embodiment advantageously comprises a tie layer composition capable of having the colorant and other additives dispersed therein, which can provide desired surface finish properties for the multilayer film.

This surface layer generally comprises a thermoplastic polymer. Thermoplastic polymers suitable for use in the surface layer are those that are characterized by optical transparency, improved weatherability, chemical resistance, and low water absorption. It is also generally desirable that the thermoplastic polymer have good melt compatibility with the tie layer composition of the tie layer. Suitable thermoplastic polymers are polycarbonate including polyester-polycarbonate, or blends of polyesters with polycarbonates. Polyesters, where used in a blend, may be cycloaliphatic polyesters, polyarylates or a combination of cycloaliphatic polyesters with polyarylates. Specifically useful are polyester-polycarbonates.

In an embodiment, the polyester-polycarbonates include polyester units comprising polyarylates, which can be copolymerized to form arylate-ester and carbonate blocks. Included can be polyester-polycarbonates comprising structural units of the formula (20): 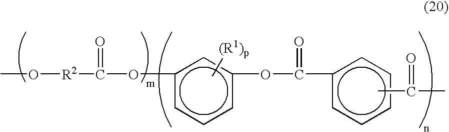
wherein each R¹ is independently halogen or C₁₋₁₂ alkyl, m is at least 1, p is about 0 to about 3, each R² is independently a divalent organic radical, and n is at least about 4. Specifically n is at least about 10, more specifically at least about 20 and most specifically about 30 to about 150. Specifically m is at least about 3, more specifically at least about 10 and most specifically about 20 to about 200. In an exemplary embodiment m is present in an amount of about 20 and 50. In a specific embodiment, the weatherable composition is a poly(isophthalate-terephthalate-resorcinol)-co-polycarbonate copolymer.

In other embodiment, the superstrate comprises two layers, for example as shown in FIG. 2 at 201. FIG. 2 depicts an article 200 comprising a multilayer film 201 having a surface layer 210, an intermediate layer 220, and a tie layer 230. A substrate 240 is included on a face of the tie layer 230. In an embodiment, intermediate layer 220 comprises additives including, for example, colorants and/or fillers to provide optical effect. In another embodiment, one or more of tie layer 230 and intermediate layer 220 can comprise additives.

The multilayer film may further comprise an intermediate layer, wherein the intermediate layer can be contacted to a surface of the tie layer. In a specific embodiment, a first tie layer is contacted to a first surface of the intermediate layer, and a second tie layer is contacted to a second surface of the intermediate layer opposite the first tie layer. In another embodiment, the superstrate comprises one or more layers in addition to the surface layer and disposed between the surface layer and the tie layer, at least one layer of which can be a second tie layer. In a specific embodiment, the multilayer film comprises a surface layer, a first tie layer contacted to the surface layer, and a second tie layer contacted to the first tie layer on a side opposite the surface layer. In another specific embodiment, an additional, intermediate layer is disposed between the first and second tie layers. In an embodiment, the intermediate layer comprises a suitable thermoplastic polymer.

A suitable thermoplastic polymer for use in an intermediate layer can have suitable film forming properties, including, for example, color capability, coefficient of thermal expansion, melt flow, ductility, adhesion, a combination comprising one or more of these properties, and the like.

Suitable intermediate layers can comprise polycarbonates as defined hereinabove. In a specific embodiment, the polycarbonate can be a blend with polymers such as polyesters; polyester-polycarbonates; polysiloxane-polycarbonates; impact modifiers; a combination comprising one or more of these, and the like. Specific examples of polymers suitable for use in the intermediate layer include, but are not limited to, bisphenol A polycarbonate, poly(phthalate-carbonate) (PPC), poly(isophthalate-terephthalate-resorcinol)-co-(bisphenol-A carbonate), acrylonitrile-butadiene-styrene terpolymer, styrene-acrylonitrile copolymer, acrylonitrile-styrene-acrylate terpolymer, combinations comprising one or more of these, and the like.

In one embodiment, a specifically suitable combination of polymers for use in the intermediate layer comprises bisphenol A polycarbonate polymer and a poly(phthalate-carbonate) (PPC) polymer, wherein the polyester unit of the PPC polymer is derived from the reaction of a combination of isophthalic and terephthalic diacids (or derivatives thereof) with bisphenol A. In a specific embodiment, the poly(phthalate-carbonate polymer can be a poly(isophthalate-terephthalate-bisphenol A)-co-(bisphenol A carbonate) of formula (21): 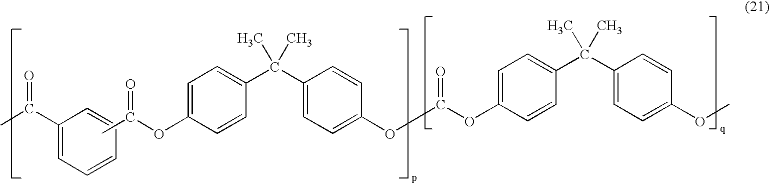
wherein the ratio of isophthalate units to terephthalate units is 50:50 to 99:1, specifically 85:15 to 97:3; and the polycarbonate unit is derived from bisphenol A such that the ratio of the mixed isophthalate-terephthalate polyester unit p to the polycarbonate unit q is 99:1 to 1:99, more specifically 95:5 to 30:70.

In an embodiment, the intermediate layer can also include additives to provide optical effects. Specifically, additives suitable for use in providing optical effects are described hereinabove and can include, for example, colorants and/or filler, wherein the filler can comprise light reflective and/or refractive filler.

In another embodiment, where it is not desirable to use an intermediate layer in a multilayered film, such as for example, wherein the multilayer film comprises a surface layer contacted to a tie layer, and a substrate contacted to a side of the tie layer opposite the surface layer, the tie layer can further comprise additives for optical effects.

In other embodiment, the superstrate comprises three or more layers, for example as shown in FIG. 3 at 301. FIG. 3 depicts an article 300 comprising a multilayer film 301 having a surface layer 310, a first tie layer 320, an intermediate layer 330, and a second tie layer 340. A substrate 350 is included on a face of the second tie layer 340. In an embodiment, intermediate layer 330 comprises additives including, for example, colorants and/or fillers to provide optical effect. In another embodiment, one or more of first tie layer 320, intermediate layer 330, and second tie layer 340 can comprise additives.

Thus, in one embodiment, the superstrate comprises a surface layer disposed on the tie layer. In a further embodiment, an intermediate layer is disposed between the surface layer and the tie layer. In another further embodiment, an additional tie layer is disposed between the surface layer and the additional tie layer, wherein the second tie layer comprises a polycarbonate, and a poly(alkylene ester), and wherein the intermediate layer is disposed on the first tie layer. In another embodiment, a second tie layer can be disposed between the first tie layer and the surface layer.

It is contemplated herein that the additives for providing an optical effect in the multilayer film can be present in any one of a number of combinations wherein, for example, the colorant is present in a different layer than the filler, or alternatively, different combinations of colorants and/or fillers are present in different layers. It will be appreciated by one skilled in the art that the multilayer film disclosed herein may be used with a variety of combinations of additives and layers to provide different and useful optical effects combinations within the scope of this disclosure, that the multilayer films disclosed herein are not limited to the particular combination and or numbers of additives and layers, and compositions thereof disclosed in the foregoing exemplary embodiments. The multilayer films disclosed herein should therefore not be considered as limited thereto.

Thus, the tie layer of the multilayer film can have a thickness of about 1 to about 100 mils (about 25 to about 2,540 micrometers), specifically about 2 to about 75 mils (about 50 to about 1,905 micrometers), more specifically about 3 to about 60 mils (about 76 to about 1,524 micrometers), and still more specifically about 5 to about 50 mils (about 125 to about 1,270 micrometers). The surface layer can have a thickness of about 1 to about 50 mils (about 25 to about 1,270 micrometers), specifically about 2 to about 40 mils (about 50 to about 1,016 micrometers), more specifically about 3 to about 30 mils (about 76 to about 762 micrometers), and still more specifically about 5 to about 20 mils (about 125 to about 508 micrometers). The intermediate layer can have a thickness of about 1 to about 100 mils (about 25 to about 2,540 micrometers), specifically about 5 to about 75 mils (about 125 to about 1,905 micrometers), more specifically about 8 to about 60 mils (about 203 to about 1,524 micrometers), and still more specifically about 10 to about 50 mils (about 254 to about 1,270 micrometers). The multilayer film can have a total thickness of about 3 to about 500 mils (about 76 to about 12,700 micrometers), specifically about 4 to about 250 mils (about 102 to about 6,350 micrometers), more specifically about 5 to about 200 mils (about 125 to about 5,080 micrometers), and still more specifically about 10 to about 100 mils (about 125 to about 2,540 micrometers).

Mismatch between coefficients of thermal expansion (CTE) of the tie layer, and surface layer and/or intermediate layer, and an underlying substrate may induce very high thermal stress and cause curl in the multilayer films and/or delamination in the articles comprising the multilayer films (also referred to herein as “multilayer articles”). In various embodiments of the present invention the adhesive layer can be formulated for applications with multilayer articles comprising said second layer and substrate layer with different coefficients of thermal expansion (CTE), for example, a high CTE second layer on a low CTE substrate.

It has been observed that a multilayer film comprising a tie layer comprising a tie layer composition comprising a polycarbonate and an impact modifier, may possess adequate but limited adhesion to a substrate, wherein the tie layer of the multilayer film is contacted to a polyurethane substrate layer. The adhesion between the tie layer and the polyurethane (PU) substrate is typically about 3 to about 5 pli (about 525 to about 875 N/m) wherein the impact modifier is an ASA or SAN impact modifier, and adhesion is typically about 15 pli (about 2,625 N/m) where the impact modifier is an ABS impact modifier. Further, when contacted to a surface layer comprising a weatherable composition, the adhesion between the weatherable surface layer and the tie layer comprising such a composition in a multilayer film may be less than or equal to about 8 pli (about 1,400 N/m), and the adhesion between the tie layer and a polycarbonate intermediate layer has been observed to be less than about 32 pli (about 5,600 N/m). While the adhesion, specifically the adhesion between the tie layer and substrate, according to the foregoing peel pull strength values may be suitable at present for articles having a low thermoforming draw ratio (i.e., a draw ratio of 1:1 or less, wherein the depth (i.e., thickness) of the multilayer film-substrate article is less than or equal to the width), for higher thermoforming draw ratios (greater than 1:1, wherein the article's depth is greater than the width), this lower degree of adhesion, as distributed over a smaller contact area, may provide inadequate adhesion between the multilayer film and substrate. This is especially pronounced in conjunction with the increased aspect ratio of the article providing additional mechanical stresses, such as, for example, coefficient of thermal expansion mismatch between the tie layer and the substrate.

Surprisingly, it has been found that a tie layer, prepared from a tie layer composition comprising a blend of a polycarbonate and a poly(alkylene ester), has excellent adhesion to the superstrate (i.e., intermediate layer and/or surface layer) in a multilayer film which includes the tie layer. The adhesion so obtained is improved over existing tie layer compositions comprising polycarbonate and impact modifier. In addition, improved adhesion is obtained between a substrate and the tie layer prepared from the polycarbonate and poly(alkylene ester) tie layer composition. Specifically, the adhesion of the tie layer to the substrate is improved wherein the substrate comprises polycarbonate or polyurethane.

Without wishing to be bound by theory, the increased adhesion between layers may be attributable to a more even match of surface properties of the blend of polycarbonate and poly(alkylene ester) in the tie layer composition disclosed herein, with both the adjacent superstrate layers having polycarbonate, and with substrate layers comprising, for example, polyurethane or polycarbonate. Polycarbonate and poly(alkylene esters) are sufficiently similar in functionality and structure that they can have a high miscibility sufficient to form a uniform blend, and thus can provide a highly compositionally uniform surface when extruded to form a layer. As used herein, a “uniform blend” is one wherein no phase separated regions are observed in the blend using typical observation methods such as scanning electron microscopy or transmission electron microscopy. Polycarbonate and poly(alkylene esters) are also sufficiently different in individual properties such that a blend of these acts synergistically to provide improved surface properties of a tie layer prepared from this blend. In contrast, an impact modifier (IM) such as, for example, ABS or other acrylonitrile and/or rubber-containing polymer, may have a limited miscibility with polycarbonate due to a greater dissimilarity in different physical properties of the polymers such as, for example, polarity and functional group compatibility. A blend of polycarbonate and IM therefore may present a less uniform surface when formed into a layer, one that may not be sufficiently matched in surface properties with adjacent polycarbonate and/or polyurethane layers to provide a sufficiently high degree of adhesion. Thus, a tie layer comprising a tie layer composition as disclosed hereinabove has improved adhesion to adjacent superstrate and/or substrate layers, over that seen where the tie layer comprises a polycarbonate blended with an impact modifier.

The adhesion between the multilayer film comprising the tie layer comprising the tie layer composition, and a polyurethane substrate layer, as determined by initiation peel pull strength, can be about 20 to about 60 pli (about 3,500 to about 10,500 N/m), specifically 25 to about 50 pli (about 4,375 to about 8,750 N/m), more specifically about 30 to about 45 pli (about 5,250 to about 7,875 N/m), measured in accordance with the peel pull test as described below.

In an embodiment, the measured value for adhesion between the tie layer comprising the tie layer composition, and the superstrate, as measured by initiation peel pull strength, can be greater than about 10 pli (greater than about 1,750 N/m), specifically greater than about 20 pli (greater than about 3,500 N/m), more specifically greater than about 30 pli (greater than about 5,250 N/m), and still more specifically greater than about 35 pli (greater than about 6,175 N/m), measured in accordance with the peel pull test as described below.

In a specific embodiment, the measured value for adhesion between the tie layer comprising the tie layer composition, and the surface layer, as measured by initiation peel pull strength, can be greater than about 10 pli (greater than about 1,750 N/m), specifically greater than about 20 pli (greater than about 3,500 N/m), more specifically greater than about 30 pli (greater than about 5,250 N/m), and still more specifically greater than about 35 pli (greater than about 6,175 N/m), measured in accordance with the peel pull test as described below.

In another specific embodiment, the measured value for adhesion between the tie layer comprising the tie layer composition, and the intermediate layer comprising a polycarbonate, as measured by initiation peel pull strength can be greater than about 50 pli (greater than about 8,750 N/m), specifically greater than about 60 pli (greater than about 10,500 N/m), and more specifically greater than about 65 pli (greater than about 11,375 N/m), and still more specifically greater than about 70 pli (greater than about 12,250 N/m), measured in accordance with the peel pull test as described below.

Where tie layers comprising impact-modified polycarbonate are contacted to the surface layer comprising the weatherable composition, defects such as “brush-line” defects have been observed to appear in the surface layer. Such defects are typically observed when ABS or other styrene-nitrile copolymers are used in a blend with polycarbonate. Without wishing to be bound by theory, it is believed the ABS type polymer, which has a lower glass transition temperature than the polycarbonate, solidifies later than the polycarbonate upon extrusion. This Tg mismatch can cause stresses within the film due to accompanying volume changes upon cooling of the ABS, which in turn are believed to create fine structural features, such as striations, within the film. These striations are believed to cause an interference pattern in light reflected from and/or refracted through the film, giving rise to the observed brush line defects.

This effect can be mitigated, in polycarbonate/ABS films, by use of low molecular weight, lower Tg polyester-polycarbonates in the weatherable composition of the adjacent layer, which is believed to provide a more plastic coating over the impact modified PC that is less prone to show a visible brush line pattern. However, the use of impact modified polycarbonate in a tie layer can thereby limit the useful molecular weight of weatherable compositions used for the surface layer, i.e., poly(isophthalate-terephthalate-resorcinol) polymers (also referred to herein as ITR polymers), wherein the molecular weight (Mw) of these polymers has an upper limit of about 20,000 amu. It is advantageous from a manufacturing perspective to be able to use a higher molecular weight polymer in the weatherable composition for the surface layer, as the manufacture of lower molecular weight polymers, specifically ITR polymers having an Mw less than about 20,000, can lead to greater variability in the properties of the ITR polymer. Where a lower molecular weight is used, the isolated ITR polymers can have greater variability in film forming properties such as viscosity, melt-flow index, ductility, and the like. Such variation can lead to decreased batch-to-batch reproducibility in one or more film forming properties of the ITR polymer, and further can lead to decreased process yield and increased cost for both the isolation of the polymer, and for the multilayer films produced therewith.

Polycarbonates and poly(alkylene esters) are believed to be more closely matched in Tg, and therefore tie layer compositions comprising blends of these can have lower levels of stress and accompanying defect features within the films. Therefore, use of a tie layer composition comprising a blend of polycarbonate and poly(alkylene ester), when coextruded with a surface layer comprising a weatherable composition, can provide a multilayer film which, when viewed with the naked eye at an ordinary viewing distance of about 30 to about 150 centimeters under ordinary lighting conditions, has an appearance that is free of brush line defects. Defectivity may be minimized where the top and tie layers each comprise tie layer compositions having more closely matched coefficient of thermal expansion. Thus, where the tie layer comprises a tie layer composition that is CTE-matched to the weatherable composition, and is coextruded with a surface layer comprising the weatherable composition, the weatherable composition can comprise an ITR polymer having Mw greater than about 20,000.

The use of a tie layer, so prepared from the tie layer composition, also has excellent film forming capability including color capability. This provides a tie layer to which optical effects additives such as colorants and/or filler may be added, to provide an alternative composition for an optical effects layer. Further, the tie layer composition is reduced in gel content relative to intermediate layer compositions comprising PPC polymer as a polymeric additive, and thus can have a lower defectivity due to the absence of gels. Thus, a tie layer comprising the tie layer composition as described hereinabove can, when incorporated into a multilayer film, provide a low defectivity replacement layer for the PPC polymer-containing intermediate layer of a multilayer film, where such a replacement is desired.

Nitrile-containing impact modifiers, such SAN and ABS for example, are typically provided as aqueous emulsions, and are more hygroscopic than the polyesters disclosed herein. Moisture uptake of PC/ABS/SAN can typically be greater than 0.15% of the weight of the film, upon exposure of the PC/ABS/SAN film to conditions of 50% relative humidity at about 21° C. High moisture content can be disadvantageous in the formation of articles, as it can lead to lower adhesion between the multilayer film and the substrate. It has been observed, however, that tie layer compositions comprising polycarbonates and poly(alkylene esters) generally have significantly lower moisture uptake by an order of magnitude than those prepared from polycarbonate with ABS and/or SAN. The lower moisture uptake is advantageous in the manufacture of articles wherein the multilayer films prepared using the tie layer composition thereby do not require drying prior to thermoforming. In addition, use of aqueous emulsions of impact modifiers have been found to decrease the hydrolytic stability of polycarbonates during extrusion, leading to local hydrolysis of phase separated concentrations of aqueous residues. This can be evident particularly during thin-film extrusion, which may be observed as breakouts or pinhole defects in which local hydrolysis of the polycarbonate may show up as a surface defect. Use of blends of polycarbonate with poly(alkylene ester) to form the tie layer can mitigate this phenomenon, and can provide a multilayer film which, when viewed with the naked eye at an ordinary viewing distance of about 30 to about 150 centimeters and under ordinary lighting conditions, has an appearance that is free of break-out defects.

Thus, a multilayer film comprising the tie layer comprising a blend of polycarbonate and poly(alkylene ester) can have a moisture uptake of less than or equal to 0.10 wt %, specifically less than or equal to 0.075 wt %, specifically less than or equal to 0.05 wt %, more specifically less than or equal to 0.03 wt %, and still more specifically less than or equal to 0.02 wt %, wherein the amount of moisture uptake is expressed as a percentage by weight of the multilayer film comprising the tie layer.

The multilayer film can be prepared using extrusion methods. Specifically, the multilayer film may be extruded as individual films, and contacted to each other to form a multilayer film. Suitable methods for application include fabrication of a separate sheet of coating layer followed by application to the second layer, as well as simultaneous production of both layers. Alternatively, the multilayer film can be prepared by coextrusion with an additional layer, wherein application of a first layer to a second layer is performed in the melt. Thus, there may be employed such illustrative methods as molding, compression molding, thermoforming, co-injection molding, coextrusion, extrusion coating, melt coating, overmolding, multi-shot injection molding, sheet molding and placement of a film of the coating layer material on the surface of the second layer followed by adhesion of the two layers, typically in an injection molding apparatus; e.g., in-mold decoration.

The multilayer film may generally be produced by extrusion followed by laminating the sheets in a roll mill or a roll stack. The extrusion of the individual layers of the multilayer film may be performed in a single screw extruder or in a twin screw extruder. It is desirable to extrude the layers in a single screw extruder and to laminate the layers in a roll mill. It is more desirable to co-extrude the layers in a single screw extruder or twin screw extruder and to optionally laminate the layers in a roll mill. The roll mill may be either a two roll or three roll mill, as is desired. Co-extrusion of the layers by single screw extruders is generally desirable for the manufacturing of the multilayer film.

In an embodiment, in the extrusion of the tie layer and the surface layer, the additives (e.g., colorant and/or filler) may be added to the extruder along with the polymer at the feed throat. In another embodiment, in the coextrusion of the tie layer and the surface layer, the additives may be added to the extruder in the form of a masterbatch. While the polymer is fed to the throat of the extruder, the masterbatch may be fed either at the throat of the extruder or downstream or the throat. In an embodiment, in the production of the tie layer, the polymer (i.e., polycarbonate) is fed to the throat of a single screw extruder while the additives are added in masterbatch form downstream of the feed throat. In another embodiment, in the production of the surface layer, the polymer (i.e., thermoplastic polymer) is fed to the throat of a single screw extruder. In a specific embodiment, where an intermediate layer may also be coextruded, additives can be added to the extruder in the form of a masterbatch.

In an embodiment, the desired composition for the tie layer and the surface layer may be separately precompounded prior to coextrusion. In this event, the precompounded materials may be first melt blended in a twin screw extruder, single screw extruder, buss kneader, roll mill, or the like, prior to being formed into a suitable shapes such as pellets, sheets, and the like, for further co-extrusion. The precompounded tie and surface layer compositions, and where desired, intermediate layer composition, may then be fed into the respective extruders for co-extrusion.

As stated above, it is desirable to co-extrude the top and the tie layer, and intermediate layer where included. In an embodiment, in one manner of co-extruding of the multilayer film, the melt streams (extrudates) from the various extruders are fed into a feed block die where the various melt streams are combined before entering the die. In another embodiment, the melt streams from the various extruders are fed into a multi-manifold internal combining die. The different melt streams enter the die separately and join just inside the final die orifice. In yet another embodiment, the melt streams from the various extruders are fed into a multi-manifold external combining die. The external combining dies have completely separate manifolds for the different melt streams as well as distinct orifices through which the streams leave the die separately, joining just beyond the die exit. The layers are combined while still molten and just downstream of the die. A die used in the production of the multilayer film is a feed block die. In an embodiment, the extruders used for the co-extrusion of the top and tie layers, and intermediate layer where included, can be single screw extruders respectively.

The use of PC/ABS/SAN tie layer compositions can limit the rate of extrusion of the multilayer film to a maximum practical value of about 5 feet per minute (fpm; 152.4 centimeters per minute (cm/min)), at or below which rate the film uniformity and the defectivity remain within tolerable levels. Tie layers comprising polycarbonate and poly(alkylene esters), however, can have low defectivity at higher extruder throughputs of up to about 10 fpm (304 cm/min) due to significantly reduced accompanying buildup of excess extrudate at the die lip (i.e., outlet end of the film extrusion die), when compared with die lip buildup observed during extrusion of the PC/ABS/SAN compositions. Thus, in an embodiment, the multilayer films comprising a tie layer comprising polycarbonate and poly(alkylene ester) can be extruded at an overall extrusion rate for the multilayer film of about 3.5 to about 10 fpm (about 107 to about 304 cm/min), specifically about 3.75 to about 9.75 fpm (about 114 to about 297 cm/min), more specifically about 4.0 to about 9.5 fpm (about 122 to about 290 cm/min). Multilayer films comprising a tie layer comprising polycarbonate and poly(alkylene ester) can thus be extruded at these rates without significant die lip buildup. The increased film extrusion rates for the tie layer compositions disclosed herein can thereby provide a wider operating window for the manufacture of the multilayer films, which is desirable from the perspective of increased throughput, reduced cycle time, and greater control over multilayer film quality.

Tie layer compositions as disclosed herein can have greater melt-stability than polycarbonate blends with impact modifiers such as SAN and/or ABS. As noted herein, the presence of acidic or basic components in aqueous emulsion based impact modifiers such as SAN and/or ABS can lead to undesirable side reactions including cross-linking or increase in molecular weight by grafting. Greater melt-stability is thus a desirable feature during extrusion, as it can mitigate or eliminate increases in viscosity during prolonged periods of heating that can have a detrimental impact on further processing, process cycle time, and equipment lifetime. In addition, tie layer compositions can be less prone to devolatilization during extrusion. It has been observed that the use of impact modifiers provided as emulsions, such as SAN and/or ABS, as described above, has been found lead to significant amounts of volatile components in the composition, which can in turn volatilize during melt blending and extrusion. Increased devolatilization can lead to formation of bubbles, voids, or roughness in the extruded multilayer film, that can manifest as observable defects. Polycarbonate blends with poly(alkylene ester) have a lower level of volatile components that devolatilize during extrusion, and thus the tie layer compositions disclosed herein have a lower resin devolatilization during extrusion, and a lower level of defectivity in the film.

The multilayer film, after formation by extrusion, may be subject to post-extrusion processing such as, for example, rolling or calendaring. Where the multilayer film is subject to calendaring by rolling between two rollers to improve the uniformity of the multilayer film, a portion of the multilayer film may remain on the rollers and can build up (also referred to as “plate out”) over time. This build-up of material on the rollers may in turn cause defects in the calendared multilayer film by transfer of some of the excess material to the multilayer film, creating irregularities in the film surface which may be observable as defects. The use of the tie layer composition described herein has been found to mitigate the formation of build-up of excess material on the rollers, and thus can provide a multilayer film having a lower incidence of surface defects.

The substrate can be contacted to the tie layer of the multilayer film by laminating, calendaring, rolling, or otherwise bonding the tie layer to the substrate using heat and/or pressure. An adhesive may also be used to bond the tie layer to the substrate. The substrate may also be coextruded with the multilayer film comprising the tie layer to form a multilayer structure. Alternatively, the substrate can be molded to the multilayer film comprising tie layer. The molding of the substrate may be done either before or after forming the tie layer.

The multilayer film can be contacted to the substrate layer by use of known methods, for example lamination using heat and pressure as in compression molding, or using other forming techniques such as vacuum forming or hydroforming. An adhesive layer may optionally be used, wherein the adhesive layer may be applied to a side of the multilayer film having an exposed side of the tie layer, and contacting the adhesive layer to the substrate. Alternatively, the adhesive layer can be applied to the substrate layer, and the multilayer film having an exposed side of the tie layer can be contacted thereto. For adhesive already in film form the adhesive layer can be formed adjacent to the tie layer in the multilayer film either after or during a process (such as coextrusion) to form the multilayer film, and become an integral part of the multilayer film, which can be directly formed by contacting the multilayer film to the substrate using processes using, for example, heat and pressure.

Alternatively, the tie layer, surface layer, and optionally the intermediate layer can be coextruded to form the multilayer film, wherein an exposed side of the multilayer film can be the tie layer. Assembly of a multilayer film with a pre-formed substrate layer may be done using known methods such as lamination. The multilayer film-substrate assembly can be optionally thermoformed to the approximate shape of an article before molding, wherein the article is formed by molding the assembly in a subsequent step. Alternatively, the substrate can be molded to a surface of the multilayer film to form the multilayer film-substrate assembly as a sheet. The assembly may be cut, shaped, sectioned, or otherwise pre-formed to the approximate shape of an article, and thermoformed and/or molded to the desired shape.

In an embodiment, an article comprises: (i) a first tie layer comprising polycarbonate and poly(alkylene ester); (ii) a surface layer comprising a weatherable composition disposed on a side of the tie layer; (iii) optionally an intermediate layer and/or second tie layer disposed on a side of the first tie layer opposite the surface layer, wherein when both are used, the second tie layer can be disposed on a side of the intermediate layer opposite the first tie layer; and (iv) a substrate layer, wherein the substrate layer is in contiguous contact with the first tie layer, or optionally where used, the second tie layer. The article may be prepared by a method comprising assembling the tie layer, surface layer, optional intermediate layer and/or second tie layer to form a multilayer film, thermoforming and/or molding the multilayer film into a shape, and molding a substrate to a side of the multilayer film having a tie layer exposed. In an embodiment, the article may be subjected to heat for curing and/or annealing.

Specifically, it is desirable to apply in the melt a structure comprising the tie layer, surface layer, and where desired, optional intermediate layer and/or second tie layer, to a substrate layer. This may be achieved, for example, in an embodiment, by charging an injection mold with the structure comprising the tie layer, surface layer, and where desired, optional intermediate layer and/or second tie layer, and injecting the substrate behind it. By this method, in-mold decoration and the like are possible. In one embodiment both sides of the substrate layer may receive the multilayer film, while in another embodiment, multilayer film can be applied to only one side of the substrate.

In one embodiment, a specifically useful method of molding is long-fiber injection (LFI), wherein the substrate material and a reinforcing fiber such as, for example, glass rovings cut to a length of about 10 to about 100 millimeters, are combined simultaneously in a mold during molding. In a specific embodiment, the substrate comprises a long-fiber injected polyurethane (LFI-PU). In another embodiment, a specifically useful method is reaction injection molding (RIM). In this method, at least two components comprising a thermoset, such as for example a diisocyanate and diol, that produce a polyurethane upon reacting, are mixed just prior to injection into the mold. The components react upon entering the mold. In a specific embodiment, the substrate is a reaction injection molded polyurethane (RIM-PU).

The multilayer films as described above, and as applied to the substrate to form the article, are specifically useful in paint replacement layers where the multilayer film may be contacted with the substrate by a thermoforming process, such as in-mold decorating or thick sheet forming.

The multilayer articles comprising the various layer components of this invention are typically characterized by the usual beneficial properties of the substrate layer, in addition to weatherability as may be evidenced by such properties as improved initial gloss, improved initial color, improved resistance to ultraviolet radiation and maintenance of gloss, improved impact strength, and resistance to organic solvents encountered in their final applications. Depending upon such factors as the coating layer/substrate combination, the articles may possess recycling capability, which makes it possible to employ the regrind material as a substrate for further production of articles of the invention. The articles often exhibit low internal thermal stress induced from CTE mismatch between layers. The articles may also possess excellent environmental stability, for example thermal and hydrolytic stability.

Articles which can be made which comprise the various layer components of this invention include: exterior and interior components for aircraft, automotive, truck, military vehicle (including automotive, aircraft, and water-borne vehicles), scooter, and motorcycle, including panels, quarter panels, rocker panels, vertical panels, horizontal panels, trim, fenders, doors, decklids, trunklids, hoods, bonnets, roofs, bumpers, fascia, grilles, mirror housings, pillar appliques, cladding, body side moldings, wheel covers, hubcaps, door handles, spoilers, window frames, headlamp bezels, headlamps, tail lamps, tail lamp housings, tail lamp bezels, license plate enclosures, roof racks, and running boards; enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; optical lenses; ophthalmic lenses; corrective ophthalmic lenses; implantable ophthalmic lenses; wall panels, and doors; counter tops; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; shoe laces; articles made from plastic-wood combinations; golf course markers; utility pit covers; computer housings; desk-top computer housings; portable computer housings; lap-top computer housings; palm-held computer housings; monitor housings; printer housings; keyboards; FAX machine housings; copier housings; telephone housings; phone bezels; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated foam articles; and like applications. The invention further contemplates additional fabrication operations on the articles, such as, but not limited to, molding, in-mold decoration, baking in a paint oven, lamination, and/or thermoforming.

The above properties are further illustrated by the following non-limiting examples.

Peel strength was determined according to the following method. Samples of the composite film were cut into one-inch wide stripes and tested for peel resistance of the adhesive bond using a 90-degree peel test with a crosshead separation speed of 5 inches (12.7 cm) per minute using an Instron Peel Strength Tester from Instron. The method used is as follows. A sample is first allowed to cool 10 minutes after removal from the production line. Using a strip scribe unit, three 7 inch long (18 cm) samples are cut to 1 inch (2.5 cm) width along the machine direction. Each strip is peeled back approximately 1 inch (2.5 cm), the peeled section doubled over by folding, and the folded sections clamped in the instrument. The material is pulled apart at a rate of 10 inches (12.7 cm) per minute, at an angle of 90°. Three measurements are taken at different places on each sample. The mean peel adhesion is recorded in pounds of force (lb.) per linear 1-inch (2.54 cm) strip width. The peel strength (P) was then calculated as follows:
P=[peeling load, in pounds)]/[width of specimen (inches)], and converted to metric units of Newtons per meter (N/m) as needed, by multiplying the value in lb/in by a conversion factor of 175.

All thermoplastic compositions were compounded using a single or twin screw extruder with sufficient distributive and dispersive mixing elements to produce good mixing between the polymer compositions. The compositions are subsequently extruded to form multilayer films using a single screw extruder from Davis-Standard or HPM Taylor Industries equipped with a single- or multi-manifold die and with or without feedblock, further described below. Compositions are compounded at a temperature of 285 to 330° C., though it will be recognized by one skilled in the art that the method may not be limited to these temperatures.

The components used in the preparation of examples of the multilayer films are given in Table 1. The components were compounded to provide the given formulations and comparative formulations according to the proportions given in Table 2.

TABLE 1

| Acronym | Description | Trade Name | Supplier |
|---|---|---|---|
| PC | Bisphenol A polycarbonate, Mw = 20,000 | LEXAN ™ | GE Plastics |
| | to 36,000 | | |
| ITR-PC | Poly(isophthalate-terephthalate- | LEXAN ™ ITR | GE Plastics |
| | resorcinol) polyester - bisphenol A | | |
| | polycarbonate, Mw = 15,000 to 40,000 | | |
| PCTG | poly(1,4-cyclohexanedimethylene | — | GE Plastics |
| | terephthalate)-co-poly(ethylene | | |
| | terephthalate), <50% PET, Mw = 40,000 | | |
| | to 80,000 | | |
| PETG | poly(1,4-cyclohexanedimethylene | — | GE Plastics |
| | terephthalate)-co-poly(ethylene | | |
| | terephthalate), >50% PET, Mw = 40,000 | | |
| | to 80,000 | | |
| PCCD | Poly(1,4-cyclohexanedimethylene-1,4- | — | GE Plastics |
| | cyclohexanedicarboxylate, Mw = 60,000 | | |
| | to 100,000 | | |
| 2210 Lotader | Ethylene-acrylic ester-maleic anhydride | 2210 Lotader ™ | Arkema |
| | terpolymer | | Group |
| 3210 Lotader | Ethylene-acrylic ester-maleic | 3210 Lotader ™ | Arkema |
| | anhydride terpolymer | | Group |
| 3410 Lotader | Ethylene-acrylic ester-maleic | 3410 Lotader ™ | Arkema |
| | anhydride terpolymer | | Group |
| AX8900 | Ethylene-acrylic ester-glycidyl | AX8900 | Arkema |
| Lotader | methacrylate terpolymer | Lotader ™ | Group |
| ABS | Acrylonitrile-Butadiene-Styrene | CYCOLAC ™ | GE Plastics |
| | Terpolymer | #MG47F- | |
| | | NA1003 | |
| SAN | Styrene-Acrylonitrile Copolymer | — | GE Plastics |
| TPU 301 | Thermoplastic polyurethane | ISOPLAST ™ | DOW |
| | | 301 | Chemicals |
| TPU 202EZ | Thermoplastic polyurethane | ETPU-202EZ | DOW |
| | | | Chemicals |
| Diepoxy | Cycloaliphatic epoxy resin (hydrolysis | ERL-4221 | Dow |
| | stabilizer) | | Chemicals |
| EXCY 0076 | 75% PC 19% ABS 6% SAN | CYCOLOY ™ | GE Plastics |
| | | EXCY0076-100 | |
| C100HF | 51% PC 19% ABS 30% SAN | CYCOLOY ™ | GE Plastics |
| | | C1000HF | |
| C1200 | 73% PC 14% ABS 13% SAN | CYCOLOY ™ | GE Plastics |
| | | C1200 | |

TABLE 2

| | PC | Additive A | Additive | | Additive | |
|---|---|---|---|---|---|---|
| Formulation No. | (wt %) | (Polymer) | A (wt %) | Additive B | B (wt %) | Comments |
| Form. 1 | 75 | PCTG | 25 | — | — | 75:25 PC/PCTG |
| Form. 2 | 64 | PCTG | 36 | — | — | 64:36 PC/PCTG |
| Form. 3 | 56 | PCTG | 44 | — | — | 56:44 PC/PCTG |
| Form. 4 | 75 | PETG | 25 | — | — | 75:25 PC/PETG |
| Form. 5 | 60 | PCCD | 40 | — | — | 60:40 PC/PCCD |
| Form. 6 | 40 | PCCD | 60 | — | — | 40:60 PC/PCCD |
| C. Form. 1 | 99 | L2210¹ | 1 | — | — | 99:1 PC/L2210 |
| C. Form. 2 | 95 | L2210¹ | 5 | — | — | 95:5 PC/L2210 |
| C. Form. 3 | 90 | L2210¹ | 10 | — | — | 90:10 PC/L2210 |
| C. Form. 4 | 99 | L3410¹ | 1 | — | — | 99:1 PC/L3410 |
| C. Form. 5 | 95 | L3410¹ | 5 | — | — | 95:5 PC/L3410 |
| C. Form. 6 | 90 | L3410¹ | 10 | — | — | 90:10 PC/34210 |
| C. Form. 7 | 99 | L3210¹ | 1 | — | — | 99:1 PC/L3210 |
| C. Form. 8 | 95 | L3210¹ | 5 | — | — | 95:5 PC/L3210 |
| C. Form. 9 | 90 | L3210¹ | 10 | — | — | 90:10 PC/L3210 |
| C. Form. 10 | 99 | AX 8900 | 1 | — | — | 99:1 PC/AX |
| C. Form. 11 | 95 | AX 8900 | 5 | — | — | 95:5 PC/AX |
| C. Form. 12 | 90 | AX 8900 | 10 | — | — | 90:10 PC/AX |
| C. Form. 13 | 75 | ABS | 19 | SAN | 6 | EXCY 0076 |
| C. Form. 14 | 51 | ABS | 19 | SAN | 30 | C1000HF |
| C. Form. 15 | 73 | ABS | 14 | SAN | 13 | C1200 |
| C. Form. 16 | 75 | PPC | 25 | — | — | PC/PPC |
| C. Form. 17 | 96 | PMMA | 4 | — | — | 96:4 PC/PMMA |
| C. Form. 18 | 92 | PMMA | 8 | — | — | 92:8 PC/PMMA |
| C. Form. 19 | 99.5 | Diepoxy | 0.5 | — | — | 99.5:0.5 PC/DEP |
| | | ERL4221 | | | | |
| C. Form. 20 | 99 | Diepoxy | 1 | — | — | 99:1 PC/DEP |
| | | ERL4221 | | | | |
| C. Form. 21 | 0 | ITR | 100 | — | — | ITR |

¹Pellet blend

Examples of 2-Layer Film Construction. Coextrusion of tie-layer formulations with ITR (C. Form. 21), PC/PPC (C. Form 16), and TPU was performed to determine whether the tie layer formulations (Table 2) were coextrudable with these materials. The two-layer films were prepared using a single-manifold coextrusion die (i.e., a “coathanger” die) with a feedblock, and 2″ (5 cm) and a 1-1/4″ (3 cm) diameter main- and side-extruders, respectively. The die and feed block were operated at a temperature of 500 to 520° F. (260 to 271° C.). The PC-polyester tie layer formulations (Forms. 1-6, C. Forms. 1-9 and 17-20) were extruded at 430 to 450° F. (221 to 232° C.), the PC+ABS resins (C. Forms. 13-15) at 440-470° F. (227 to 243° C.), the TPU resins at 400-460° F. (204 to 238° C.), the ITR resin (C. Form. 21) at 440 to 460° F. (227 to 238° C.), and the PC/PPC resin (C. Form. 16) at 480 to 530° F. (249 to 277° C.). The pilot extrusion line was operated using a polish/polish roll configuration, with roll temperatures of 180 to 240° F. (82 to 116° C.); specifically, a rubber #3 roll at a temperature of about 230° F. (about 110° C.) was used.

The 2 layer film constructions produced according to the above method are shown in Table 3.

TABLE 3

| | Tie Layer | | | |
|---|---|---|---|---|
| | (10 mil/254 μm); | | | |
| | 30 mil/762 μm | Surface layer | Intemediate layer | Other Layer |
| Examples | where noted^{b}) | (10 mil/254 μm) | (30 mil/762 μm) | (10 mil/254 μm) |
| Ex. 1 | Form. 1 | — | C. Form. 16 | |
| Ex. 2 | Form. 1^{b} | C. Form. 21 | — | |
| Ex. 3 | Form. 2 | — | C. Form. 16 | |
| Ex. 4 | Form. 2^{b} | C. Form. 21 | — | |
| Ex. 5 | Form. 3 | | C. Form. 16 | |
| Ex. 6 | Form. 3^{b} | C. Form. 21 | — | |
| Ex. 7 | Form. 4 | | C. Form. 16 | |
| Ex. 8 | Form. 4^{b} | C. Form. 21 | — | |
| Ex. 9 | Form. 5 | | C. Form. 16 | |
| Ex. 10 | Form. 5^{b} | C. Form. 21 | — | |
| Ex. 11 | Form. 6 | | C. Form. 16 | |
| Ex. 12 | Form. 6^{b} | C. Form. 21 | — | |
| Comp. Ex. 1 | C. Form. 1 | — | C. Form. 16 | |
| Comp. Ex. 2 | C. Form. 2 | — | C. Form. 16 | |
| Comp. Ex. 3 | C. Form. 3 | — | C. Form. 16 | |
| Comp. Ex. 4 | C. Form. 4 | — | C. Form. 16 | |
| Comp. Ex. 5 | C. Form. 5 | — | C. Form. 16 | |
| Comp. Ex. 6 | C. Form. 7 | — | C. Form. 16 | |
| Comp. Ex. 7 | C. Form. 8 | — | C. Form. 16 | |
| Comp. Ex. 8 | C. Form. 10 | — | C. Form. 16 | |
| Comp. Ex. 9 | C. Form. 11 | — | C. Form. 16 | |
| Comp. Ex. 10 | C. Form. 12 | — | C. Form. 16 | |
| Comp. Ex. 11 | C. Form. 13 | — | C. Form. 16 | |
| Comp. Ex. 12 | C. Form. 14 | — | C. Form. 16 | |
| Comp. Ex. 13 | C. Form. 15 | — | C. Form. 16 | |
| Comp. Ex. 14 | | C. Form. 21 | C. Form. 16 | |
| Comp. Ex. 15 | C. Form. 17^{b} | — | | C. Form. 13 |
| Comp. Ex. 16 | C. Form. 18^{b} | — | | C. Form. 13 |
| Comp. Ex. 17 | C. Form. 19^{b} | — | | C. Form. 13 |
| Comp. Ex. 18 | C. Form. 20^{b} | — | | C. Form. 13 |
| Comp. Ex. 19 | | — | C. Form. 16 | TPU-301^{a} |
| Comp. Ex. 20 | | — | C. Form. 16 | TPU-202EZ |

^{a}Could not be co-extruded with PC
^{b}30 mil film thickness

Co-extrusion of the above films was accomplished with all formulations screened, using either PC/PPC and/or ITR, without significant issues or problems. Thermoplastic polyurethane TPU 301 showed insufficient melt strength at the given coextrusion process conditions, and could not be co-extruded with either PC/PPC or ITR formulations.

Peel Strength Evaluation of 2 layer films. The films from Table 3 were back-molded with PC/PPC (to measure the film's interlayer cohesive strength), ABS, and with LFI-PU foam.

Adhesion data from the 90° peel pull test, both initiation as well as propagation values, are given in Table 4a (Comparative Examples 1-18, 20) and Table 4b (Examples 1-16). The results are reported using the following descriptive terms: no adhesion (NA) is an adhesion of 0 pli (0 N/m), which denotes an initial non-interaction between film layers and/or back molded substrate; delamination (D) is an adhesion of less than 1 pli (less than 175 N/m), wherein the layers are readily separated without significant applied force; adhesion failure (AF) greater than or equal to 1 pli (greater than or equal to 175 N/m), which denotes the loss of adhesion between specific layers early under peel strength test conditions; cohesive failure (CF), in which a layer separates by splitting itself rather than undergoing adhesion failure at the interface with an adjacent layer; and no delamination (ND), wherein the layers show no evidence of separation at either a layer-to-layer interface or within a layer, under peel strength test conditions of up to 113 pli (19,775 N/m).

TABLE 4a

| | Tie Layer Adhesion To: | | | | | | | |
|---|---|---|---|---|---|---|---|---|
| | Intermediate | | Top layer | Top layer | | Substrate | | |
| | layer adhesion | Intermediate layer | adhesion | adhesion | Substrate | LFI- | Substrate | |
| | PC/PPC, | adhesion PC/PPC, | ITR, in pli | ITR, in pli | LFI-PU, in | PU, in pli | ABS, in pli | Substrate ABS, |
| | in pli (N/m) | in pli (N/m) | (N/m) | (N/m) | pli (N/m) | (N/m) | (N/m) | in pli (N/m) |
| | Initiation | Propagation | Initiation | Propagation | Initiation | Propagation | Initiation | Propagation |
| CEx. 1 | 36.2 (6,335) | 12.8 (2240) | — | — | — | — | 16.1 (2,818) | 3.3 (578) (AF) |
| CEx. 2 | 42.1 (7,368) | 23.2 (4,060) | — | — | D | D | 12.1 (2,118) | 2.7 (473) (AF) |
| CEx. 3 | 6.9 (1,208) | 4.7 (823) | — | — | — | — | 7.3 (1,278) | 2.9 (508) (AF) |
| CEx. 4 | 19.8 (3,465) | 10.7 (1,873) | — | — | — | — | 13.0 (2,275) | 1.8 (315) (AF) |
| CEx. 5 | 38.8 (6,790) | 19.2 (3,360) | — | — | D | D | 9.3 (1,628) | 2.0 (350) (AF) |
| CEx. 6 | 57.7 (10,098) | 24.4 (4,270) | — | — | — | — | 9.7 (1,698) | 2.4 (420) (AF) |
| CEx. 7 | 30.5 (5,338) | 15.2 (2,660) | — | — | — | — | 3.1 (543) | 1.5 (263) (AF) |
| CEx. 8 | 31.8 (5,565) | 9.2 (1,610) | — | — | D | D | 5.5 (963) | 3.4 (595) (AF) |
| CEx. 9 | 11.5 (2,013) | 2.2 (385) | — | — | — | — | 4.6 (805) | 1.2 (210) (AF) |
| CEx. 10 | 3.3 (578) | — | — | — | — | — | NA | NA |
| CEx. 11* | 31.4 (5,495) | 12.9 (2,258) | — | — | 23.2 (4,060) | 17.9 (3,133) | 15.2 (2,660) | 11.5 (2,013) |
| | | | | | | (CF) | | (AF) |
| CEx. 12 | 27.3 (4,778) | 10.2 (1,785) | — | — | — | — | 25.8 (4,515) | 13.7 (2,398) |
| | | | | | | | | (CF) |
| CEx. 13 | — | 7.0 (1,225) | — | — | — | — | 4.1 (718) | 2.2 (385) (AF) |
| CEx. 14 | 31.4 (5,495) | 12.9 (2,258) (CF) | 7.7 (1,348) | — | 28 (4,900) | 21.2 (3,710) | 8.6 (1,505) | 4.3 (753) (AF) |
| CEx. 15 | 76.3 (13,353) | 29.2 (5,110) (CF) | — | — | 21.9 (3,833) | 17.4 (3,045) | — | 2.6 (455) (AF) |
| CEx. 16 | 54.0 (9,450) | 43.4 (7,595) (CF) | — | — | — | — | — | 4.0 (700) (AF) |
| CEx. 17 | 36.9 (6,458) | 7.1 (1,243) (CF) | — | — | — | — | — | 5.7 (998) (AF) |
| CEx. 18 | 37.2 (6,510) | 9.1 (1,593) (CF) | — | — | — | — | — | 10.7 (1,873) |
| | | | | | | | | (AF) |
| CEx. 20 | 3.5 (613) | — | — | — | — | — | 3.6 (630) | 2.0 (350) (AF) |

TABLE 4b

| | Tie Layer Adhesion To: | | | | | | | |
|---|---|---|---|---|---|---|---|---|
| | Intermediate | | Top layer | Top layer | | | | |
| | layer adhesion | Intermediate layer | adhesion | adhesion | Substrate | Substrate LFI- | Substrate | |
| | PC/PPC, | adhesion PC/PPC, | ITR, in pli | ITR, in pli | LFI-PU, in | PU, in pli | ABS, in pli | Substrate ABS, |
| | in pli (N/m) | in pli (N/m) | (N/m) | (N/m) | pli (N/m) | (N/m) | (N/m) | in pli (N/m) |
| | Initiation | Propagation | Initiation | Propagation | Initiation | Propagation | Initiation | Propagation |
| Ex. 1 | ND | ND | — | — | — | — | 1.9 (333) | 1.7 (298) (AF) |
| Ex. 3 | ND | ND | — | — | — | — | — | — |
| Ex. 5 | ND | ND | — | — | — | — | — | — |
| Ex. 7 | ND | ND | — | — | — | — | 1.8 (315) | 1.5 (263) (AF) |
| Ex. 9 | 79.5 (13,912) | 44.1 (7,718) | — | — | D | D | 7.4 (1,295) | 2.2 (385) (AF) |
| Ex. 11 | ND | ND | — | — | D | D | 2.4 (420) | 2.6 (455) (AF) |
| Ex. 2 | — | — | 36.9 (6,478) | — | 56 (9,800) | 28.3 (4,953) | — | — |
| Ex. 4 | — | — | 44.5 (7,788) | — | 63 (11,025) | 34.8 (6,090) | — | — |
| Ex. 6 | — | — | ND | ND | 48 (8,400) | 32.3 (5,653) | — | — |
| Ex. 8 | — | — | 11.9 (2,082) | — | 42.7 (7,473) | 23.0 (4,025) | — | — |
| Ex. 10 | — | — | D | D | 51.7 (9,048) | 37.4 (6,545) | — | — |
| Ex. 12 | — | — | D | D | 67.8 (11,865) | 35.2 (6,160) | — | — |

Key:
ND = no delamination;
D = delamination;
CF = cohesive failure;
AF = adhesive failure;
NA = No Adhesion.
Numbers, where reported, indicate measured value for peel pull value at a 95% confidence level.
Init. = peel pull initiation strength, in pounds per linear inch, pli (Newtons per meter, N/m);
Prop. = peel pull propagation strength, pli (Newtons per meter, N/m).
*Control.

Adhesion to the PC co-extruded layer. Examples 1-12 (Table 4b; PC blended with polycarbonates PCTG, PETG, PCCD at levels of 25 wt % to 60 wt % polyester) showed excellent adhesion to the PC/PPC intermediate layer composition, with no delamination detected for Examples 1, 3, 5, 7, and 11 (PC/PCTG and PC/PETG blends). Example 9 (60:40 weight ratio PC/PCCD) showed high initiation/propagation peel pull strengths of 79.5 pli (13,913 N/m) and 44.1 pli (7,718 N/m), respectively. Tie-layers comprising PC with 1 wt % or 5 wt % L3210 or L2210 (CEx 1, 2, 4, and 5), and 4 or 8% PMMA (CEx 15, 16) also provided higher adhesion levels than CEx 11 (control; CYCOLOY™ EXCY0076-100), but not as good as the polyester blends. The remaining formulations each demonstrated lower adhesion values than CEx 11 (control).

Adhesion to Co-extruded ITR Layer. The PC/PCTG blends (Ex. 2, 4, and 6) each provided higher adhesion strength than that of the control film (ITR-PC/PPC; CEx 14). Of these, Ex. 6 (56:44 PC/PCTG) demonstrated no delamination, and therefore showed the strongest adhesion to the ITR surface layer. Generally, PC/PCTG blends demonstrate higher values for the peel pull test, and hence better adhesion to the ITR surface layer, than the control (CYCOLOY™ EXCY0076-100) currently used as a tie layer composition.

Adhesion to LFI-PU Foam. All of the examples showed acceptable adhesion to the LFI-PU substrate at the thicker tie layer thickness. The lowest adhesion value (initiation) found was for Ex. 8 (25 wt % PETG containing tie layer formulation with ITR-PC top layer, 30 mil/762 micrometers thickness). Examples 9 and 11 (PCCD containing tie layer formulations with ITR-PC top layer, 10 mil/254 micrometers thickness) showed delamination during peel pull testing with polyurethane substrate; however, Ex.s 10 and 12 (also PCCD containing tie layer formulations with PC-PPC intermediate layer, 30 mil/762 micrometers thickness) had good adhesion to the polyurethane substrate. Comparative Example 11, the control sample, showed marginally acceptable initiation adhesion and unacceptable propagation adhesion to polyurethane. Comparative Example 14, which showed marginally acceptable adhesion to polyurethane, had a polyurethane substrate molded to the intermediate layer polycarbonate formulation C. Form 16 (PC/PPC blend). Other comparative examples showed unacceptable adhesion to polyurethane.

Adhesion to ABS Substrate. The CYCOLOY™ grade C1000HF (C. Form. 14, used in CEx 12), when back-molded with an ABS substrate, gave slightly better adhesion than the currently used CYCOLOY™ EXCY0076-100 tie-layer (control). All other screened formulations demonstrated unacceptable adhesion.

Moisture uptake. Samples of multilayer films (without substrate) from Example 4 and Comparative Example 11 were each tested for moisture uptake, according to the following procedure: samples of multilayer film of about the same dimensions were each weighed and placed in a humidity controlled chamber at 50% relative humidity (RH) and at a temperature of 21° C. for a period of 10 minutes. The samples were removed from the chamber, re-weighed, and the difference in weight determined. The moisture uptake was calculated as the percentage increase in weight of the sample so treated over the initial sample. The resulting moisture uptake for Example 4 was 0.011% by weight, and for Comparative Example 11 was 0.165% by weight. Example 4 shows a desirably low moisture uptake relative to the control (CEx 11).

All cited patents, patent applications, and other references are incorporated herein by reference in their entirety. The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. All ranges disclosed herein are inclusive of the endpoints, and endpoints directed to the same characteristic are independently combinable with each other.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof.

We claim:

1. An article comprising:
a polymer substrate; and
a multilayer film comprising:
a superstrate comprising a polycarbonate; and
a tie layer comprising a tie layer composition comprising:
a polycarbonate, and
a poly(alkylene ester),
wherein the tie layer is disposed between the substrate and the superstrate; and the article has an initiation peel strength between the tie layer and the substrate of about 20 to about 60 pounds per linear inch (about 3,500 to about 10,500 Newtons per meter), measured at a 90° peel angle and a peel rate of 12.7 cm/min.

2. The article of claim 1, wherein the polycarbonate and poly(alkylene ester) are present in the tie layer composition in a weight ratio of about 85:15 to about 30:70.

3. The article of claim 1, wherein the poly(alkylene ester) comprises poly (1,4-cyclohexanedimethylene-1,4-cyclohexanedicarboxylate), poly((1,4-cyclohexanedimethylene terephthalate)-co-(1,2-ethylene terephthalate)) having less than or equal to 50 wt % of 1,4-cyclohexanedimethylene terephthalate ester units; poly((1,4-cyclohexanedimethylene terephthalate)-co-(1,2-ethylene terephthalate)) having greater than 50 wt % of 1,4-cyclohexanedimethylene terephthalate ester units; or a combination comprising one or more of the foregoing poly(alkylene esters).

4. The article of claim 1, wherein the tie layer composition further comprises an additive, and wherein the additive is a colorant, filler, flame retardant, impact modifier, anti-drip agent, plasticizer, or a combination comprising at least one of the foregoing additives.

5. The article of claim 1, wherein the tie layer of the multilayer film can have a thickness of about 1 to about 100 mils (about 25 to about 2,540 micrometers).

6. The article of claim 1 wherein the superstrate is a surface layer.

7. The article of claim 6, wherein the surface layer comprises a weatherable composition comprising a poly(isophthalate-terephthalate-resorcinol) copolymer.

8. The article of claim 6 wherein the adhesion between the tie layer and the surface layer, as measured by peel pull strength, is greater than about 10 pounds per linear inch (greater than about 1,750 Newtons per meter), measured at a 90° peel angle and a peel rate of 12.7 cm/min.

9. The article of claim 1, wherein the superstrate comprises a surface layer and an intermediate layer disposed between the surface layer and the tie layer.

10. The article of claim 9 wherein the adhesion between the tie layer and the intermediate layer, as measured by peel pull strength, is greater than about 30 pounds per linear inch (greater than about 5,250 Newtons per meter), measured at a 90° peel angle and a peel rate of 12.7 cm/min.

11. The article of claim 10, wherein the intermediate layer comprises bisphenol-A polycarbonate, poly(phthalate carbonate), or a combination comprising one or more of these.

12. The article of claim 9, wherein the superstrate comprises an additional tie layer disposed between the surface layer and the intermediate layer.

13. The article of claim 12, wherein the adhesion between the additional tie layer and the surface layer, as measured by peel pull strength, is greater than about 10 pounds per linear inch (greater than or equal to about 1,750 Newtons per meter), measured at a 90° peel angle and a peel rate of 12.7 cm/min; and wherein the adhesion between the additional tie layer and the intermediate layer, as measured by peel pull strength, is greater than about 30 pounds per linear inch (greater than about 5,250 Newtons per meter), measured at a 90° peel angle and a peel rate of 12.7 cm/min.

14. The article of claim 1, wherein the substrate comprises a polyurethane, a polycarbonate, a polyester, a acrylonitrile-butadiene-styrene terpolymer, a thermoplastic polyolefin, or a combination comprising one or more of these.

15. The article of claim 14, wherein the polyurethane is a long-fiber injected polyurethane (LFI-PU) or a reaction injection molded polyurethane (RIM-PU).

16. The article of claim 1, wherein the multilayer film has a moisture uptake of less than or equal to 0.1 wt %, wherein the amount of moisture uptake is expressed as a percentage by weight of the multilayer film comprising the tie layer.

17. The article of claim 1, wherein the multilayer film has an appearance that is free of brush line defects, and wherein the multilayer film has an appearance that is free of breakout defects.

18. A method of forming a multilayer film comprising coextruding:
a superstrate, with
a tie layer comprising a tie layer composition comprising:
a polycarbonate, and
a poly(alkylene ester),
wherein the superstrate is contacted to the tie layer, and wherein the initiation peel strength between the tie layer of the multilayer film and a substrate contacted thereto is about 20 to about 60 pounds per linear inch (about 3,500 to about 10,500 Newtons per meter), measured at a 90° peel angle and a peel rate of 12.7 cm/min.

19. The method of claim 17, wherein the multilayer film is extruded at an overall extrusion rate of about 3.5 to about 10 fpm (about 107 to about 304 cm/min).

20. A method of forming an article, comprising molding
a polymer substrate, to
a multilayer film comprising:
a superstrate comprising a polycarbonate; and
a tie layer comprising a tie layer composition comprising:
a polycarbonate, and
a poly(alkylene ester),
wherein the polymer substrate is molded to a side of the film comprising the tie layer, and wherein the article so prepared has an initiation peel strength between the tie layer and the polymer substrate of about 20 to about 60 pounds per linear inch (about 3,500 to about 10,500 Newtons per meter), measured at a 90° peel angle and a peel rate of 12.7 cm/min.

21. A multilayer film comprising:
a superstrate, wherein the superstrate comprises a polycarbonate,
a tie layer comprising a combination of
a polycarbonate, and
a poly(alkylene ester), wherein the poly(alkylene ester) comprises poly (1,4-cyclohexanedimethylene-1,4-cyclohexanedicarboxylate), poly((1,4-cyclohexane dimethylene terephthalate)-co-(1,2-ethylene terephthalate)) having less than or equal to 50 wt % of 1,4-cyclohexanedimethylene terephthalate ester units; poly((1,4-cyclohexanedimethylene terephthalate)-co-(1,2-ethylene terephthalate)) having greater than 50 wt % of 1,4-cyclohexanedimethylene terephthalate ester units; or a combination comprising one or more of the foregoing poly(alkylene esters);
wherein the polycarbonate and poly(alkylene ester) are present in the tie layer composition in a weight ratio of about 85:15 to about 30:70, and wherein the adhesion between the tie layer and the superstrate, as measured by peel pull strength, is greater than about 10 pounds per linear inch (greater than about 1,750 Newtons per meter), measured at a 90° peel angle and a peel rate of 12.7 cm/min.
